(19) United States
(12) Patent Application Publication
(10) Pub. No.: US 2023/0322203 A1
(43) Pub. Date: Oct. 12, 2023

(54) SYSTEM AND METHOD FOR THE MANAGEMENT OF REGENERATIVE-BRAKING FOR BATTERY RECHARGING IN A HYBRID ELECTRIC VEHICLE

(71) Applicant: Hydrogen Vehicle Systems Ltd, Glasgow (GB)

(72) Inventor: David Telford, Portpatrick (GB)

(21) Appl. No.: 18/298,717

(22) Filed: Apr. 11, 2023

Related U.S. Application Data
(60) Provisional application No. 63/362,802, filed on Apr. 11, 2022.

(51) Int. Cl. B60W 20/15; H01M 8/04992; B60W 10/18; B60W 40/12; B60L 3/12; B60W 10/04; B60L 7/16

(52) U.S. Cl. CPC B60W 20/15; H01M 8/04992; B60W 10/18; B60W 40/12; B60L 3/12; B60W 10/04; B60L 7/16; H01M 2250/20; B60W 2530/00; B60W 2710/18; B60L 2210/10; B60L 2210/40

(57) ABSTRACT

There is provided a control system for a vehicle comprising a powertrain comprising a plurality of energy sources, the plurality of energy sources comprising a battery, the control system being configured to actively monitor, control and optimise power recapture from regenerative-braking in the vehicle. More specifically a controller and related control system for the energy balancing of the vehicle taking into consideration such factors as fuel usage, power management between the various power generating and storage sub-systems, regenerative braking, terrain topology, weather and other environmental conditions, operation of vehicle peripherals and parasitic power demands in addition to cargo management and environmental needs and driver comfort and safety, as well as vehicle fleet management.

### CROSS REFERENCE TO RELATED APPLICATIONS

This application claims priority to and the benefit of U.S. Application No. 63/362,802, filed Apr. 11, 2022; the contents of which as are hereby incorporated by reference in their entirety.

### TECHNICAL FIELD

The present invention relates to hybridized fuel cell systems for transportation applications, more specifically to the use of these systems in light-to-medium-to-heavy good vehicles. More particularly the invention relates to the holistic control and management of all key factors related to the energy balancing of fuel usage, power generation. energy storage, as well as parasitic load management and peripherals energy demand within the vehicle. More specifically, SEMAS (System Energy Management using Adaptive Simulation), the controller and related control system for the energy balancing of the vehicle takes into consideration such factors as fuel usage, power management between the various power generating and storage sub-systems, regenerative braking, terrain topology, weather and other environmental conditions, operation of vehicle peripherals and parasitic power demands in addition to cargo management and environmental needs and driver comfort and safety, as well as vehicle fleet management. Specifically providing a series of controls strategies, processes and hardware that actively monitor, control, and optimize power recapture from regenerative-braking in zero-emission HGVs.

### BACKGROUND

Society has a pressing and urgent need to reduce carbon emissions and move away from its reliance on traditional fossil fuels. As a result, efforts have been made in recent times to adopt alternative fuel vehicles which do not rely on traditional petroleum fuels, such as, petrol and diesel. Such alternative fuel vehicles include battery electric vehicles, fuel cell electric vehicles, plug in hybrid electric vehicles, hybrid electric vehicles including mild hybrids.

For large commercial vehicles, particularly in the Medium Goods vehicle (MGV) to HGVs classes hybrid fuel cell powertrains offer a zero-emission, when fuelled by hydrogen, alternative to diesel, and are a potentially more viable solution to all battery electric powertrains, due to:
Ability to pull heavy cargo loads
Long duty cycle/range capability
Fuel cells are engines that provide power if there is available fuel
Quick Refuelling time

At present the 4×2 diesel tractor unit is a general work horse for many types of heavy goods commercial vehicle applications from relatively lightly loaded curtain side trailers to heavy shipping container, road tankers, car transporters and other heavy duty articulated lorry applications.

Commercial vehicles are used to transport goods and materials from source to destination, for the purposes of this disclosure, commercial which include, but are not limited to LGV, MGV and HGV. To do this cost effectively and with minimal environmental impact is a prime requirement to support a modern economy.

A key metric necessary for the wide-spread adoption of, hybrid fuel cell commercial vehicle is the total cost of ownership (TCO). How this is measured is a subject for debate. However, the applicant suggests that the most generally applicable metric for the commercial market, is the TCO expressed as the total cost of ownership per tonne-km, to transport a given cargo load.

Commercial vehicle applications offer, in addition to other value propositions, controlled ‘back to base’ drive cycles where refuelling can be carefully managed, and the infrastructure can be tactically implemented. An HGV offers a suitable packaging space for a fuel cell electric vehicle drivetrain, and this can be lighter in weight to an equivalent power output battery electric vehicle drivetrain. In addition, for commercial vehicles, the refuelling infrastructure can be provided co-terminus with the existing petroleum fuel infrastructure including locations and overground installations. Therefore, fuel cell electric vehicle technology is an attractive option for commercial vehicles and HGVs that operate on fixed routes.

Hybrid fuel cell electric vehicle powertrains, fueled by hydrogen fuel, offer many advantages over more conventional powertrain systems which release hydrocarbons, nitrogen oxides, carbon monoxide and other chemicals. In a fuel cell, electric energy is generated from the electrochemical reaction of hydrogen and oxygen, with the oxygen most usually sourced from air, with pure water and heat as the only emissions. In a hybrid fuel cell electric vehicle powertrain for transportation applications, a fuel cell stack is operated with reactant gas and cooling management systems, coupled with energy storage devices, such as batteries and/or supercapacitors, to produce a vehicle propulsion system. In addition, the hybridized fuel cell powertrain can provide energy to operate the necessary vehicle peripherals and, in certain case, to meet the energy demands of cargo management for trucks and trailer vehicles used in logistics transportation globally, all while taking advantage of energy recovery through processes such as regenerative braking.

Hybrid fuel cell powertrains must be actively controlled if they are to meet the market requirements of low fuel utilization, high energy efficiency, durability, and reliability, as well as providing an attractive total cost of ownership (TCO) to end users.

TCO parity between diesel and BEV or hybrid fuel cell powertrain commercial vehicles therefore depends critically on such factors as:
1. Increasing the durability of the powertrain sub-systems to deliver reasonable lifetimes
2. Efficiency of the powertrain
3. Relative costs of fuel

The powertrain for fuel cell commercial vehicles is a hybrid series/parallel electric set-up with a fuel cell sub-system, ESS (battery or equivalent), power distribution and control electronics and electric motor and mechanical drive train.

The technology for the various sub-systems in the powertrain is relatively immature, and the market does not yet offer a full range of specifications or warranty coverage for all possible applications of these sub-systems. Moreover, some sub-systems are on long lead-times from the manufacturers, and many are under development and or not yet fully field proven, especially in commercial vehicles.

As a purchaser of fuel cell and energy storage sub-systems for commercial vehicles, this presents some problems as a vehicle designer must design around what sub-systems which are presently available, and this inevitably leads to compromises and trade-offs. These limitations make it almost impossible to achieve direct parity with diesel powertrains across all performance areas. Thus, for example a commercial vehicle designer using the SEMAS controller and related control system of the present disclosure can achieve comparable ranges at the expense of cargo load, or comparable cargo load at the expense of acceleration and peak velocity.

A hybrid fuel cell powertrain designed for the commercial vehicle market is unlikely to be useful as a “plug-in hybrid” technology. The optimum powertrain design is one in which the FC is sized for the mean energy demand of the target journey and the energy storage system is then sized to take care of the peak power and transient power demands, and for overall efficiency through energy recapture in regenerative braking.

This preferred hybrid fuel cell powertrain design is quite different from either:
1. A hybrid ICE/battery powertrain where the IC engine dominant sub-system for peak power and the battery provides energy for the slow speed inefficient/start stop duty and is recharged from regenerative braking.
2. A hybrid fuel cell powertrain, where the fuel cell sub-system is operated as a range extender (typically used in buses where the energy storage sub-system is sized to supply the bulk of the energy for the journey and the peak power demand. Here the fuel cell sub-system is smaller and runs in the background providing supplementary charging during stoppages or low power demand parts of the drive cycle.

Using the fuel cell sub-system as a range extender for the energy storage sub-system produces a major challenge in powertrain design. It affects the sizing the ESS. While one would want the ESS to be as small as possible to save cost, weight and packaging space, the ESS needs to be able to, for example:
provide high power on demand to cope with high power demand transients in the drive cycle;
provide sufficient energy for the duration of these power demands;
be able to meet the charge rates to contribute to effective braking;
provide sufficient energy storage capacity to avoid wasting energy in mechanical braking; and
be able to meet the need for multiple charge discharge cycles on a single journey without compromising vehicle life.

This last point negatively impacts the durability of the powertrain and the ability to meet the desired vehicle lifetime objectives.

Number of lifetime cycles is a fundamental limitation for energy storage systems (of all chemistries) but somewhat less of an issue with supercapacitors. Energy storage systems useable life depends not just on the number of cycles but on the depth of discharge and the rate of charge/discharge, as is well-known to those skilled in the art.

These latter parameters interact in determining ESS sizing. For example, a vehicle designer may need to limit the depth of discharge to achieve acceptable cycle life, in which case the vehicle designer will end up with a larger storage capacity than required for power demand.

Similarly, for a given energy storage chemistry there will be a limit of the charge/discharge rate as a function of battery capacity. To achieve the high-power inflow and outflow needed, the energy storage capacity may need to be higher than required when considered wholly in energy storage terms.

Use of a larger that required energy storage system impacts the weight and cost of the powertrain and hence the carbo-load the vehicle can carry. It also presents packaging difficulties.

The range of properties needed for a hybrid fuel cell vehicle is not well matched with the energy storage systems available off the shelf, as such the best compromise needs to be ascertained through evaluation of design and performance requirements. It is also worth noting that both energy storage and FC sub-system durability (both electrochemical devices) are life-limited by the dynamic operation required in transportation applications.

High power transients demand from the vehicle powertrain leads to dynamic thermal stresses which have a negative impact on the lifetime of powertrain sub-systems. Both the fuel cell and energy storage sub-systems suffer high I²R (I=current and R=resistance) losses at high power demand, resulting in power efficiency losses under these operating conditions. Lower power level continuous operation is therefore preferred, where possible, and will lead to longer life for these powertrain sub-systems.

For fuel cell sub-systems, manufacturers only specify operating hours for average power demand and do not specifically mention account for the effect of dynamic power demand. However, it is known that rapid, transient power cycles are not compatible with fuel cell sub-system long life, nor is continuous operation at the highest rated power output.

The FC is sub-system with the costliest component of the powertrain, as such its life has a significant impact as regards achieving the lowest vehicle TCO for the end user.

To illustrate the scale of the challenge, consider the following example. At present, the use of a hybrid fuel cell powertrain for commercial vehicles is limited to around 450 kW peak power input to the DC/AC invertor of the PEMD. For the FC sub-system, it may be desirable, at least until the maturing of technology, increased durability and reduced cost is achieved for these sub-systems, to have a maximum of 100 kW per FC sub-system arranged in a twin FC configuration, along with an energy storage sub-system.

In practice not all the power out from the fuel cell sub-systems is available for propulsion due to power demands from BoP sub-systems, such as the electrical systems of the FC (for example, the compressor or the water pumps) and the vehicle peripherals many of which have significant energy demands.

In addition, it is desirable for the controller to accommodate changes up to the designed for end-of-life conditions when the fuel cell sub-systems power output have degraded to a point where replacement sub-systems are required.

As an example, it might be advantageous for FC life to limit FC sub-system power output to an average of around 140 kW (70 kW per FC sub-system). Calculations show that a vehicle, as one embodiment of the present disclosure, may have a peak demand of around 450 kW to accelerate a 40 tonne GVW vehicle up to speed. In the scenario described here, the FC power sub-system needs to meet the mean power demand for the journey and the fuel inventory needs to be a sufficient energy store for the journey.

Optimum energy efficiency is achieved when the ESS can also harvest and store all the available energy from the slowing and braking events experienced during the vehicle journey. When the vehicle power demand is high, beyond what the fuel cell sub-system can safely provide, the ESS needs to have sufficient stored energy in place. In addition, for the capture events, the ESS needs to have sufficient energy storage capacity to adsorb all the available energy.

For example, a full 450 kW is needed for 30 second acceleration event and the FC sub-systems is already providing a power output of 150 kW, then 300 kW is needed for those 30 seconds, which equates to 2.5 kWh of energy to be supplied.

To produce 300 kW from a 2.5 kWh battery, is not currently achievable with available battery chemistries as this corresponds to a required energy discharge of 120C. As such, it may be necessary to increase the size of the battery to meet discharge restrictions.

Hybrid fuel cell electric vehicles are complex dynamic hybrid energy systems integrating a fuel cell stack, balance of plant to handle, amongst other things, reactant gas distribution and cooling, and control systems, with an onboard energy storage system for peak power and transient demand, and regenerative braking.

Historically, the control systems for hybrid fuel cell powertrains implemented for energy management and balancing have focused on very specific operational aspects of the hybridized fuel cell system. Such an example is U.S. Pat. No. 6,376,112 in which a method is provided for the shutdown of a fuel cell system to relieve system overpressure while maintaining air compressor operation, and corresponding vent valving and control arrangement.

Also published in 2004, U.S. Pat. No. 6,794,844 describes a control system that manages the state of charge of the energy storage device relative to and in conjunction with the energy produced by a fuel cell, to achieve efficient overall operation of the hybrid power system. In U.S. Pat. No. 7,588,847, the inventors describe a control system that dampens the driver power demand in a fuel cell-battery hybrid transportation application, by managing the battery state of charge and the fuel cell ability to provide power in a coordinated and efficient manner during transients in power demand. In U.S. Pat. No. 7,599,760, a controller and control process are described whereby failure detection and corrective action is achieved while the fuel cell system continues to operate.

In a publication by Choi, S. et al, entitled “Control of Automotive PEM Fuel Cell Systems”, the authors describe the use of mathematic system modelling to create individual models for the fuel cell stack and the key balance-of-plant devices to produce a unified mini-system model of these specific subsystems. The modelling data was used to help control the operation characteristics of the mini-system to achieve enhanced performance and durability for the fuel cell subsystem. In a publication by Y. Huang et al., entitled “Adaptive Control of the Hybrid Power System in Fuel Cell City Bus”, the authors describe a control system for the power output of a fuel cell subsystem which allows for increased fuel efficiency and control of the battery pack state-of-charge to increase the lifetime of this energy storage subsystem.

In a publication by Y. Eren, et al., entitled “A Fuzzy logic Based Supervisory Controller for an FC/Ultracapacitor Hybrid,” the authors describe a supervisory controller-based power management strategy based on mathematical and electrical modelling to maximize the efficiency and durability of the hybrid power system. In U.S. Pat. No. 8,511,407, a basic systems control strategy is described for a bus powertrain comprising a fuel cell, batteries and a supercapacitor wherein each energy subsystem is employed optimally to support bus operations.

U.S. Pat. No. 10,211,470, describes a system for fuel cell temperature control related to cooling fan speed with monitoring and control of fuel consumption, where the fuel is a liquid. In U.S. Pat. No. 8,778,551, a control system is described for managing the reactant gas flows and second phase product water flows through a fuel cell to optimize power efficiency and reduce episodes of performance loss that can result in fuel cell stack component degradation.

U.S. Pat. No. 9,141,123 describes a fleet of fuel cells having a plurality of fuel cell systems connected to a data server which collects, amongst other parameters, operational data from the plurality of fuel cell systems. In U.S. Pat. No. 9,203,100 a control system is described wherein a control unit is configured to adjust fuel cell operating parameters to manage fluctuations in cell-to-cell voltage within a fuel cell stack.

In a publication by Goshtasbi, Alireza, et al., entitled “Soft Sensor for Real-Time Monitoring of Automotive PEM Fuel Cell Systems.”, the authors describe the use of a mathematical model to determine critical data concerning the internal states within operating cells in a PEM fuel cell stack. In a subsequent publication by Goshtasbi, Alireza, et al., entitled “A Mathematical Model toward Real-Time Monitoring of Automotive PEM Fuel Cells.”, the authors describe a computationally efficient model for real-time monitoring of water balancing across the membrane electrode assemblies of a PEM fuel cell operated under multiple reactant gas and fluid flow configurations, and validated using experimental performance measurements.

In a publication by Wang, Yongqiang, et al., entitled “Power Management System for a Fuel Cell/Battery Hybrid Vehicle Incorporating Fuel Cell and Battery Degradation.”, the authors describe a power management system designed to extend the lifetime of the fuel cell subsystem, while optimizing fuel consumption, for a hybrid vehicle. However, this is achieved at the expense of higher battery capacity decay.

Finally, in a publication by Caizhi Zhang, et al, entitled, “A Comprehensive Review of Electrochemical Hybrid Power Supply Systems and Intelligent Energy Managements for Unmanned Aerial Vehicles in Public Service”, the authors describe the development of data-driven models using Artificial Intelligence to produce intelligent energy management systems and controls for hybridized power generation and energy storage subsystems in unmanned aerial vehicles.

As previously explained, there is a need to reduce total cost of ownership (TCO) for a vehicle or fleet of vehicles, preferably to achieve parity or better with respect to diesel powered vehicles, even including the cost and distribution of an alternative fuel such as hydrogen. This involves a mixed objective of increasing the durability and life of the fuel cell system and energy storage devices, matching performance to the duty cycle and load, both power demand and mass and dimensions of cargo for commercial vehicles, all while reducing fuel consumption. The balance of these objectives will change dependent on the needs of the end user, so there is a desire to minimize TCO while meeting the performance requirements of each type of end user. For one type of end user, powertrain durability might be the most important factor while for another it might be extended range. Dominant requirements may also vary from journey to journey or use case to use case. As such, there is a need for a holistic, real-time vehicle controller that can measure, analyse and control system energy management using adaptive simulation to optimum the energy balance, taking into consideration all the operational factors that provide and use power, in a hybrid fuel cell vehicle.

Therefore, various improvements are needed to manage the energy requirements of a hybrid fuel cell electric vehicle. Indeed, similar requirements would be beneficial for any hybrid powertrain where there is more than one energy source wherein the vehicle has operational and performance characteristics that are required to meet transient power demand cycles, provide power for peripherals and cargo management, and where energy recapture through regenerative braking is advantageous.

### SUMMARY

According to a first aspect of the present disclosure there is provided a control system for a vehicle comprising a powertrain comprising a plurality of energy sources, the plurality of energy sources comprising a battery, the control system being configured to actively monitor, control and optimise power recapture from regenerative-braking in the vehicle.

Optionally, the control system is configured to provide one or more control signals to the powertrain, thereby controlling the regenerative-braking in the vehicle

Optionally, the control system is configured to maximise overall power efficiency from the regenerative-braking.

Optionally, the vehicle is a fuel cell electric vehicle and the plurality of energy sources comprises a fuel cell.

Optionally, the vehicle comprises a fuel cell subsystem comprising the fuel cell.

Optionally, the fuel cell comprises a hydrogen fuel cell.

Optionally, the vehicle is a zero-emission hybridised heavy goods vehicle.

Optionally, the control system comprises monitoring circuitry configured to monitor the power recapture from regenerative-braking; wherein the control system is configured to: determine an optimal power recapture; and adjust the power recapture from regenerative-braking to the optimal level, thereby providing optimised power recapture from regenerative-braking.

Optionally, the control system comprises one or more interfaces configured to receive inputs, the control and optimisation of the power recapture being dependent on the received inputs.

Optionally, at least one of the one or more interfaces is a wireless communications interface.

Optionally, the inputs comprise one or more of data from a driver of the vehicle, route data, traffic data, Global Positioning System data, terrain data, temperature data, route data, status of component data, parasitic load data, power flows in one or more subsystems of the vehicle data, DC/DC convertors and the two way DC/AC controller of the power axle data, vehicle speed and driver demand for change in speed data, temperature in fuel cell stack data, battery temperature data, current hydrogen inventory data, current battery state of charge data, current ramp rate on fuel cell data, water management data or cargo weight.

Optionally, the data comprises relates to current status and/or rate of change.

Optionally, the control system comprises a simulation module configured to provide a simulation model of the vehicle, the control and optimisation of the power recapture being dependent on the simulation model.

Optionally, the simulation module is configured to model one or more of the following in the generation of the simulation model of the vehicle: thermal management, a hydrogen fuel cell; fuel cell cooling, a high voltage DC-DC converter; a HVAC subsystem, a power distribution subsystem, a PDU and powertrain controller, an energy storage subsystem, a high voltage battery, a E-drive subsystem, an inverter, an e-axle, a hydrogen subsystem, one or more hydrogen tanks, a hydrogen supply system, hydrogen refuelling, hydrogen de-fueling, a hydrogen fuel cell subsystem, a DC-DC converter, parasitic loads, a cabin heater, an e-stop, a low voltage battery, an axle-wheel-tyre subsystem, and cargo weight.

Optionally, the simulation module is configured to provide model predictive control for controlling and optimising power recapture from regenerative braking.

Optionally, the simulation module is configured to generate a multivariant optimization model for controlling and optimising power recapture from regenerative braking.

Optionally, the control system is configured to: derive a model predictive control algorithm; define, using the derived model predictive control algorithm, a cost function to enable optimisation of the power recapture; and apply a control scheme based to optimise the power recapture based on the cost function.

Optionally, the control system is configured to: detect information relating to a current state of charge of the battery; provide the information relating to the current state of charge of the battery to the simulation model; and use model predictive control to control and optimise the power recapture from regenerative braking using the detected information relating to the current state of charge of the battery.

Optionally, the control system is configured to control the powertrain based on the ideal operating range of components of the powertrain.

Optionally, the control system is configured to be operable in one of a plurality of control modes comprising a performance mode, a balanced mode, a life extension mode, a fuel efficiency mode, a dynamic range adjust mode, a range extend mode, and a driver assist mode.

Optionally, the control system comprises a ramp rate module configured to implement a control algorithm to limit the ramp rate of one of the energy sources.

Optionally, one of the energy sources comprises a hydrogen fuel cell, the control algorithm being used to limit the ramp rate of the hydrogen fuel cell.

According to a second aspect of the present disclosure there is provided a method of actively monitoring, controlling and optimising power recapture from regenerative braking in a vehicle using the control system of any preceding claim.

It will be appreciated that the method of the second aspect may include features set out in the first aspect and can incorporate other features as described herein.

The disclosure provides an improved vehicle and vehicle control system, and methods of vehicle operation and control as disclosed herein. More specifically, the disclosure described a holistic, real-time vehicle controller that can measure, analyse and control system energy management using adaptive simulation to optimum the energy balance, taking into consideration all the operational factors that provide and use power, in a hybrid fuel cell vehicle.

The controller and related control system of the present disclosure provides for improved intelligence by incorporating multiple data sources to achieve an optimized energy balance within the operation of a vehicle, more specifically a hybrid fuel cell vehicle.

Thus, the controller and related control system of the present disclosure offers a holistic control system that measures, analyzes and controls all aspects of the energy balance in operation and utilization of the powertrain and vehicle, including but not limited to the fuel supply and use, driver safety and experience, terrain and weather considerations, vehicle peripherals, parasitic loads, cargo mass and environmental requirements, and fleet management characteristics.

Thus, an advantage of the controller and related control system of the present disclosure is that it can provide a vehicle, more specifically a hybrid fuel cell vehicle, with the lowest possible TCO ($/tonnes-km/hr). Wherein this unit of measure in terms of TCO is likely more advantageous to a commercial vehicle as opposed to a passenger vehicle.

Thus, the controller and control system of the present disclosure ensures that the energy propulsion and storage sub-systems of a vehicle powertrain are operated, individually and collectively, in a manner that ensures the optimum efficiency, durability, and safety of operation for all sub-systems, most especially for the fuel cell sub-system, in addition to providing optimum fuel efficiency for both individual vehicles, more specifically hybrid fuel cell vehicles, and for fleets of vehicles.

Thus, the controller and related control system of the present disclosure is the future “brain” of a fully autonomous powertrain for Heavy Goods Vehicles and for the fleets that operate such vehicles, more specifically for hybrid fuel cell vehicles and fleets that operate such vehicles.

Thus, the controller and related control system of the present disclosure aims to reduce the tonne-km cost calculated on a TCO basis by systematically improving durability of the powertrain sub-systems, particularly the electrochemical sub-systems (FC and Energy Storage sub-systems) and dramatically increasing the energy efficiency of the powertrain and hence the range of the vehicles.

Thus, the SEMAS controller and related control system of the present disclosure is designed to manage these trade-offs while specifying in advance the performance expectations of the vehicle powertrain for a specific journey profile and specific use case. While the challenges as described above exist for FCEV developers' similar challenges exist for other powertrain technology options including BEV and hydrogen ICEs. The SEMAS controller and related control system of this disclosure also has applicability in managing the stated challenges for these powertrain design situations.

The SEMAS controller and related control system as embodied in the software suite and toolchains of the present disclosure provides a series of tools that can be used to test vehicle configurations against specific duty cycles on both idealised drive cycles, on of real-world drive cycle and on drive cycles as defined by end users. Wherein here a tool chain refers to the set of software tools that take the software model that is a human readable interactive model, and generate suitable source code that can be compiled into low level machine readable code in the controller embodying the Model and running the MPC algorithms. It is a suite of code, generator and validation, compiler and function libraries.

For sub-system life extension, the present disclosure provides for a SEMAS controller and related control system which actively manages the energy balance for the hybrid fuel cell powertrain thereby allowing the fuel cell sub-system to operate as close to continuously at less than peak output as possible. This has important consequences for the ESS, as herein discussed, given that this sub-system will have to supply the peak power and transient power demand in a parallel configuration with the fuel cell sub-system.

The SEMAS controller and related control system of the present disclosure can be designed to ensure that the fuel cell sub-systems is operated to meet the mean power demand for the journey, and at an efficiency such that the fuel held can meet the total energy demand for the journey, the ESS, sized to produce the peak power and meet the transient power demand over that provided by the FC, This will require the energy storage sub-system to charge and discharge to provide short duration peak output and transient power demand requirements. The energy balance for this scenario will be effectively managed and controlled by the SEMAS controller and related control systems.

The SEMAS controller and related control system is designed to efficiently manage the energy balancing requirements of such a hybrid fuel cell powertrain.

### BRIEF DESCRIPTION OF THE DRAWINGS

The present disclosure will now be described by way of example only, with reference to the accompanying drawings in which:

FIG. 1 illustrates a vehicle according to the present disclosure.

FIG. 2 is a diagram illustrating a schematic for the System Energy Management using Adaptive Simulation (SEMAS) control system, according to the present disclosure;

FIG. 3 shows the controller modules that form the basis of the System Energy Management using Adaptive Simulation control system, according to the present disclosure;

FIG. 4 shows an example embodiment of the SEMAS controller hardware architecture of the present disclosure;

FIG. 5 illustrates a fleet of vehicles and a platform for fleet management, according to an aspect of the disclosure;

FIG. 6 shows a schematic of a powertrain of a hybrid fuel cell electric vehicle;

FIG. 7 shows a further schematic of a powertrain of a hybrid fuel cell vehicle in further detail.

FIG. 8 shows an overview of a control system architecture.

FIG. 9 shows a schematic of a vehicle architecture according to one example embodiment.

FIG. 10 shows a schematic of a vehicle architecture according to a further example embodiment.

FIG. 11 shows a simple schematic of the forces acting on a vehicle.

FIG. 12 shows the New European Drive Cycle.

FIG. 13 shows data for a route between Glasgow and Edinburgh on the M8 motorway.

FIG. 14 shows data relating to a real-world drive cycle.

FIG. 15 shows the power demand from a simulator for a section of a route from Manchester to Dundee as simulated; and

FIG. 16 shows an embodiment of a vehicle architecture.

### GLOSSARY

The following terms are used throughout the description of the present disclosure and as such, are further described herein:
ABS Antilock Braking System—as known in the art.
ACC Adaptive Cruise Control—Various forms of intelligent cruise control that take over the longitudinal velocity and acceleration control from the driver and adapt the motion to specific constraints such as surrounding traffic, where the adaptive cruise control may slow the vehicle below a set point to maintain a safe distance to the vehicle in front. It will be shown in the present disclosure how acceleration can be adjusted to limit peak power demand from the power train for various purposes. Both velocity and the change in velocity (acceleration) may be controlled.
ADAS Advanced Driving Assistance Systems—as known in the art.
Autonomous Levels The Society of Automotive Engineers (SAE) has defined 6 different levels of autonomous driving, as are known in the art.
BMS Battery Management System
BoP Balance of Plant, these are the additional systems that provide services to the core system function. At a sub-system level, the BoP refers to those components necessary for the sub-system to function correctly. At a whole vehicle level, it refers to those components of the vehicle that are provided in addition to the sub-systems under discussion. So for example it is common when talking about the whole powertrain to refer to everything that is not part of the powertrain sub-systems, as the balance of plant, this is everything including such items as the cab, seats, and windscreen wipers.
Driver Assist This can refer to a range of functions from simple ABS, through to level 3 automation where adaptive cruise control looks after the longitudinal velocity, while ELA an, EBS provide safety features to assist the driver. Levels 4 where there is a safety driver through to level 5 with no driver at all.
Drive Train As used herein, a drivetrain includes a group of components of a vehicle that deliver power to the drive wheels.
EBS Emergency Braking System—as known in the art.
ECU Usually Engine Control Unit. This is the electronic controller that controls the engine sub-system actuators and emission controls. More generally ECU may also refer to an Electronic Control Unit as the electronics that control a specific sub-system set of functions, for example the cooling sub-system may have an ECU that controls coolant liquid flow and fan speeds depending on temperatures.
ELA Electronic Lane Assist.—as known in the art.
ESS Energy Storage System. In an electric powertrain this may refer to the battery system but may include other energy storage technologies.
Electro-chemical As used herein this is a collective term for the two main electrochemical technologies used in the Fuel Cell hybrid vehicle, namely the battery and the Fuel Cell.
FC Fuel Cell the sub-system that converts hydrogen fuel and oxygen into electricity. In general, the FC when described as a sub-system comprises a series of Fuel Unit Cells in the form of a Fuel Cell stack and the balance of plant necessary for the proper functioning of the Fuel Cell stack.
FCEV Fuel Cell Electric Vehicle. This is a vehicle that contains one or more fuel cell sub-systems as the engine or primary propulsion device. In general, a FCEV will also have an energy storage system(s) and electricity conversion sub-systems (ESS and PEMD), energy storage devices and the Fuel Cell.
PEMD Power Electronic and Motor Drive. This is a collective term for the sub-systems that take electrical energy from the FC and ESS and transforms this through a mechanical drive system at the wheels into motive power at the wheels.
Power Train As used herein a powertrain includes energy producing and energy storage sub systems energy conversion devices, electronic motors and the drivetrain
TCO Total Cost of Ownership. A method of lifecycle costing that combines capital costs (purchase price, cost of finance amortized over the life of the vehicle) with operational costs (fuel, maintenance, cargo management, spares) to determine the total cost of ownership. This can be represented as a cost per mile or cost per year or some other comparable metric. It may also include disposal costs at end of life. Capital costs can be weighted with a NPV (Net Present Value) or taken over a fixed period with depreciation and residual values considered. When comparing TCO's care needs to be taken that the comparison is done on the same basis.

### DETAILED DESCRIPTION

Hybrid Fuel Cell vehicles are relatively complex dynamic hybrid energy systems integrating a Fuel Cell subsystem with on-board energy storage subsystem(s) for peak power demand and regenerative braking. The fuel source, depending on the fuel cell technology, is most often a high purity hydrogen stored at pressure in a bank of type approved cylinders. Hydrogen is decompressed and fed to the fuel cell where, through an electrochemical process in combination with oxygen, it provides electricity and heat. The fuel cell/energy storage system(s) combination balances fuel cell operation with the dynamic vehicle energy demand.

A key objective of the present disclosure is to reduce TCO to enable widespread adoption of hybrid fuel cell vehicles, most especially in commercial vehicles, with the ultimate goal of achieving or exceeding parity with diesel-fueled vehicles as soon as possible. While FC component costs, hydrogen costs and other elements of the TCO are on a downward trajectory, a key element in achieving lower TCO is an advanced controller and related control system as described in this disclosure that:
delivers extended life of critical components including the fuel cell and the energy storage system(s), and
optimises the operation of the powertrain to deliver increased fuel efficiency and hence extend the vehicle range.

The present disclosure provides vehicles, controllers and related control systems and accompanying methodologies for vehicle powertrains comprising hybrid fuel cell systems. A hybrid fuel cell system comprises more than one energy source with different performance characteristics. Examples include powertrains that comprise fuel cell systems in combination with energy storage systems; that may further comprise dual battery systems with high power and high energy batteries; battery and supercapacitor systems; supplementary energy sources such as solar panels; fuel cell stacks and related BoP components, combined supercapacitor and battery systems; and hybrid battery and internal combustion engine (ICE) vehicles.

The present disclosure will discuss a hybrid fuel cell electric vehicle as an example. The fuel cell will usually be a fuel cell fueled by hydrogen to provide for a zero-emission product. The disclosure also covers non-direct hydrogen fuel cell electric vehicles, for example those which employ on-board reforming, or “direct hydrocarbon reforming” as in the case of SOFC (Solid Oxide Fuel Cell), or those which use ammonia as a source of hydrogen, metal hydrides or steam methane reforming as the source of hydrogen. The disclosure may also apply to other hydrogen combustion devices or direct methanol fuel cells.

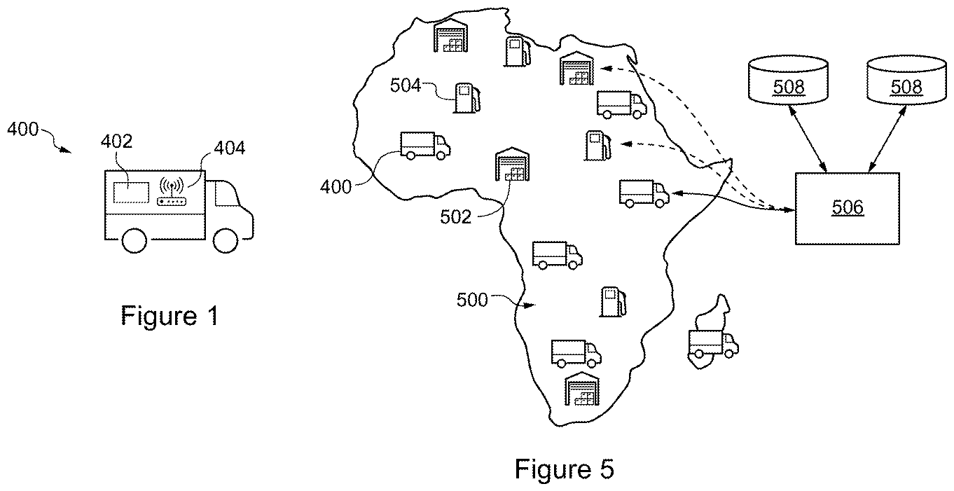

FIG. 1 shows a vehicle 400 according to the present disclosure. The vehicle 400 is provided with an energy management system controller 402 which is configured to optimize operation of the vehicle, as will be discussed in more detail below. The vehicle 400 may further be optionally provided with a communications interface 404 which may include one or more wireless antennas for transmission of data in one or more different data formats such as wireless mobile communications (GSM, 3G, 4G, 5G, 6G), Wi-Fi, Bluetooth, Zigbee, LoRaWAN.

As well as providing a modified vehicle, the present disclosure also provides for an improved controller and related control system and methodology for fleet management, as shall be herein further described.

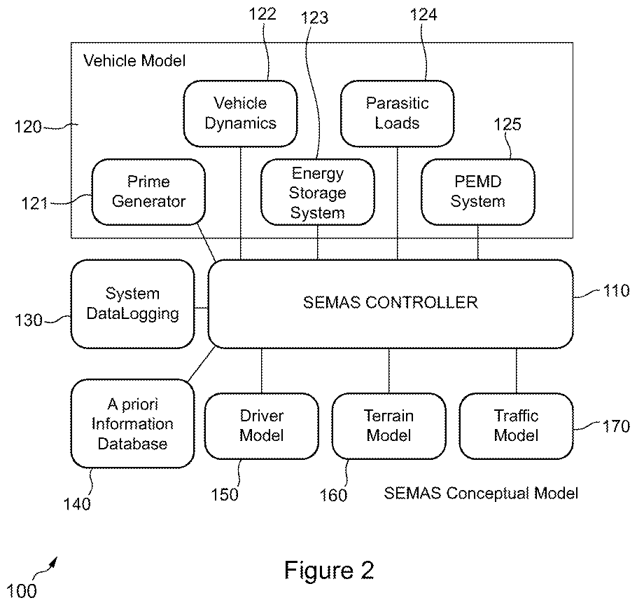

FIG. 2 illustrates a specific embodiment of a whole systems approach to energy management, based on model predictive analysis and control using multi-variant optimisation and is aimed at achieving lowest TCO for hybrid fuel cell vehicles, more specifically commercial vehicles. The SEMAS controller and related control system 100 considers energy flows at a total system level and optimises based on monitoring, analysing, and adjusting both the supply side and demand side of the total energy management for a vehicle. Where there is also energy storage system(s) then there is an opportunity to decouple and control transients in energy demand from variation in energy supply requirements.

In this disclosure, the term ‘SEMAS’ is the collective name used to refer to the controller and its related whole system energy management process, the vehicle simulation model used for predictive and adaptive control and the software that make up the suite of software that embodies a high fidelity model, the abstraction of the model embedded within the software of the controller together with a plurality of sensors and signals that make up the whole vehicle control system, as well as the software tool kit that enables this development testing and adaption of the model. SEMAS has been developed, more specifically, for application in hybrid fuel cell commercial vehicles, but may be used more broadly for other types of vehicle energy management.

The SEMAS controller and related control systems 100 components shown in FIG. 2 also comprise the SEMAS Modelling Suite, which is a set of software tools to produce and test a high-fidelity model of the vehicle and its control system, as shall be herein further described:

SEMAS Components

| | |
|---|---|
| SEMAS | Software tools to produce and test a high-fidelity model of the vehicle |
| Modelling Suite | capable of simulating the operation of the vehicle and contains |
| | software representation of the controller and the signals. The suite |
| | includes, software modules representing all the powertrain |
| | components, a Newtonian dynamics model of the vehicle and tools to |
| | run the model through standard drive cycles, and data sets |
| | representing real-world terrain and end user drive cycles. It also |
| | contains tools to generate synthetic terrain and idealised drive cycles. |
| SEMAS | A conceptual model that established the core features of SEMAS |
| Conceptual | Controller and broadly represents the main hardware and software |
| model | blocks in general terms |
| SEMAS Modules | Three primary data processing software modules within the SEMAS |
| | controller to provide the core functionality. |
| SEMAS | The basic high level on-board supervisory controller that sends data to |
| Controller | and provides settings to the sub-systems controllers on the vehicle. |
| SEMAS | On board data logger and connectivity module that connects the |
| Telematics | SEMAS controller to the SEMAS Cloud |
| SEMAS Cloud | The online database that receives data from individual vehicles, |
| | provides analyses and Fleet Management Services. It also holds |
| | libraries of a-prior route and mapping data, also provides data mining |
| | and AI (Artificial Intelligence) opportunities |
| SEMAS Sensor | The totality of vehicle sensors that are interrogated and used by |
| Suite | SEMAS. Some of them are provided for other purposes and SEMAS uses |
| | the data to understand the vehicle status and optimise operations for |
| | total vehicle energy balancing to achieve maximum fuel efficiency and |
| | range and to deliver enhanced durability of the electro-chemical sub |
| | systems. |
| SEMAS | Depending on the target operational criteria and drive mode, these |
| Algorithms | algorithms are adapted to provide the optimised drive modes. |

These components of the SEMAS controller and related control system contribute to energy management at various sub-system levels of the vehicle and represent all the powertrain components, a Newtonian dynamics model of the vehicle and tools to run the model through standard drive cycles, and data sets representing real-world terrain and end user drive cycles. The SEMAS software suite also contains tools to generate synthetic terrain and idealised drive cycles.

The SEMAS controller and related control system 100 is essential in achieving optimum operational efficiency and durability of the power train, and hence, the lowest TCO for hybrid fuel cell vehicles of the present disclosure. This is most especially true given the current technology and commercial maturity of fuel cell and battery systems, and their effective use in hybrid fuel cell vehicles.

The electrochemical technology within fuel cells and battery systems can degrade with time, limiting capacity and limiting their useful life. High power transients cycle and operating at specific parts of their operating range and can increase degradation rates, while operating at other points offer lower degradation rates. In the case of a fuel cell/battery hybrid vehicle, the prime electricity generator is the fuel cell system, which converts the on-board hydrogen fuel, with oxygen from air, via an electrochemical reaction, into electricity and heat while the battery provides for storage of electricity generated by the Fuel cell and recovered energy from regenerative braking.

The energy sources then are the available fuel, most usually hydrogen, the electricity stored in the battery or supercapacitor (generically the electrical storage system (ESS)) and the stored mechanical energy in the momentum of the vehicle. The main vehicle controller then must balance the energy flows and manage the balancing of energy supply and demand.

Wherein the high voltage energy storage system is sometimes referred to as the ESS (Energy Storage System) as this is the primary electrical energy store. It may be an electrochemical device such as a battery system or an electrical device like an array of capacitors (sometimes called a supercapacitors) or a hybrid battery capacitor system. This sub-system will often include its own controller sometimes referred to as a Battery Management System (BMS). This is the electronic device that controls the internal systems of the Battery for example managing the energy flows between the individual cells or sub-systems in the case of a hybrid battery/supercapacitor ESS.

The stored mechanical energy of the vehicle may be harvested through some form of regenerative braking to replenish the energy store. Each component of the energy store will have an energy capacity and an available power output. These combined energy store outputs are them available to drive the vehicle through the power electronics and motor drive (PEMD). The available energy will also provide the required energy for vehicle peripherals (for example, cab and cargo environmental controls).

Wherein the PEMD is the vehicle sub-system that takes electrical power and transforms it into motive power at the wheels, as known in the art. The PEMD may also have its own controller looking after power delivery, gear shift, and motor regeneration functions.

The whole energy SEMAS controller and related control system 100 also allows for demand side management, for example, to achieve vehicle range, where it may be advantageous to interrupt cargo cooling for a period to feed propulsion energy, without detriment to the viability of the cargo or to reduce extreme acceleration requests to avoid operating within a particularly damaging area of the components operating curve.

The need to make the appropriate selection of energy storage capacity to provide peak power and transient power demand of the vehicle is a dynamic problem. To maximise the benefit of the energy sub-system for regenerative braking the SOC should be low enough to absorb all the available energy. Similarly, when the vehicle is going to be called upon to provide peak power and/or transient power then the battery SOC needs to be high enough to provide the energy required. To do this at a low rate of change in both fuel cell and battery electrical power cycling, a-priori information can be used, in addition to data from onboard sensors.

In FIG. 2, the main elements of the vehicle powertrain energy system are shown together with the other elements that determine the demand side energy management characteristics of the energy system that the SEMAS controller and related control system 100 seeks to manage, as shall be herein further described.

Also shown is the SEMAS Controller 110, which is the on-board controller that sends data and settings to the various sub-systems on the vehicle, as well as the modules 150, 160, 170. This FIG. 2 establishes the core features of SEMAS and broadly represents the main hardware and software blocks in general terms. The SEMAS Controller 110 is illustrated as the supervisor controller communicating with the vehicle control sub-systems based on information from sources internal and external to the vehicle.

As mentioned, three SEMAS Modules 150, 160 & 170 are also shown, which are three primary data processing software modules within the SEMAS controller 110 to provide the core functionality. These are described as follows:
The Driver Module 150. This will include driver assist functions such as cruise control or a velocity profile input for the journey segment based on a desired drive cycle. This may also include fleet manager inputs such as available time for the journey. This element is the basic drive profile that sets the desired longitudinal velocity of the vehicle across each segment of the route.
The Terrain module 160. This represents the route data and includes the gradients along that route. Simplistically this will be a one-dimensional model of the terrain along the selected route. It is derived from the a-priori route dataset, modified by on-board gradient sensors (for example a 3 axis Inertial navigation sensor).
The Traffic Module 170. This holds dynamic information made up of “over the air” and GPS information about traffic on the chosen route together with situational awareness about the immediate surrounding traffic from on-board sensors. The traffic module also contains all required dynamic information about the current environment, such as temperature, wind, surface water, ice, and other relevant weather data. For example, if an exposed section of the planned route is closed to high-sided vehicles.

A whole vehicle module 120 is also shown, wherein its principal elements are:
1. A software representation of the vehicle dynamics 122 and the physical state variables, representing the current total mass of the vehicle, drag factor rolling resistance, vehicle load and other factors. This can be a simple 1D rigid body model or, in later iterations, a more sophisticated model with elements representing the suspension, weight transfer under braking and include articulation and lateral dynamic effects.
2. Parasitic loads 124. This module represents the information state and control of all the parts of the energy sub-systems on the vehicle that do not take part in the dynamics of the vehicle and will, for example, include electrical motors running power assistance steering and braking, pumps and fans associated with the operation of the motive sub-systems, heating and cooling of driver, cargo management, lights, and power offtakes.

The a priori database module 140 represents all the information about the proposed route that is known before the vehicle sets off. This will include all the journey specific parameters for setting the vehicle dynamics. Including vehicle weight parameters (for example vehicle load or rolling resistance) and how this will change along the route (for example the proposed cargo pick-ups and drop-offs) together with what is known about the route, in particular the a-priori module will hold the route terrain map, at its simplest, as a series of distance gradient pairs.

The SEMAS datalogging module 130 is a key element of the SEMAS control system 100 and provides the ability to log information on the vehicle performance and how well it is performing on a given route. These data sets are the critical parameters of each of the subsystems of the power train (power output, temperature, hydrogen level, battery, State of Charge etc.) will be stored as time series data sets for each of the selected measured parameters of each of the selected parameters of those sub systems.

Global positioning system (GPS) data will also be collected to correlate time series state data with position of the vehicle on the route. These data sets are then uploaded by on board telematics to a SEMAS Cloud and are then available for analysis and comparison with original predictive model in the SEMAS software suite. These data are used to refine the model and make updates available to the a-priori database to improve performance over a repeat of that route. This will provide a rich dataset for machine learning and provision of fleet management and control.

The data logging module 130 can also include records of parameters that relate to “driver safety”. For example, it could include the total hours of operation before break, cargo and/or cab environmental needs during longer breaks (overnight).

The fundamental basis of the SEMAS controller and related control system 100 is to use high fidelity dynamic models of the vehicle sub-systems together with detailed a-prior data alongside a suite of on-board sensors to dynamically adjust the sub-systems states to manage the energy flows between the prime generator, energy storage systems and the energy demand elements.

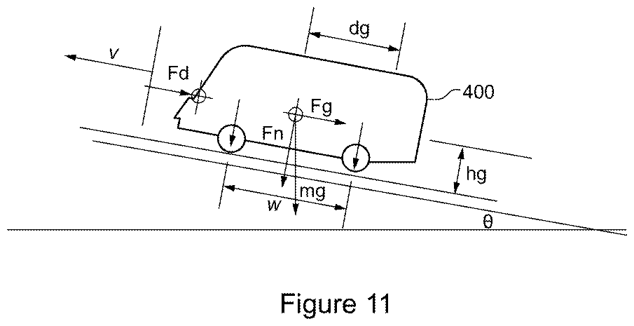

The dynamic element 122 of the vehicle module 120 in FIG. 2 is a simple Newtonian equation of state. A simple version showing one embodiment of this is shown in FIG. 11 below. FIG. 11 shows the main forces that operate on a vehicle. The tractive effort of the powertrain needs to overcome the rolling resistance, aerodynamic drag and if the vehicle is a on an up incline to lift the mass of the vehicle up the gradient. If the vehicle is also accelerating, then the power demand increases in proportion to the rate of acceleration and, critically for commercial vehicles, the inertial mass of the vehicle.

When the vehicle of the present disclosure is on the level and operating at constant velocity then the power demands are much less as the powertrain only needs to overcome the rolling resistance and the aerodynamic drag of the vehicle.

In a more sophisticated embodiment of the SEMAS controller and related control system 100, the dynamics element of the vehicle model can include a full articulated 3-dimensional dynamic representation, which can include features such as load transfer under cornering. As is known in the art, when a vehicle is on a downward incline or is decelerating then a braking effort needs to be applied. Traditionally this has simply been friction brakes where the inertial energy of forward motion is dissipated as heat in the braking system.

With an electrical powertrain there is the opportunity to recover some of this energy in the battery system by reversing power flows. Virtually all hybrid fuel cell vehicles offer some form of regenerative braking. With an LGV or HGV vehicle, then the available energy from braking can be considerable, particularly when the driver needs to decelerate the vehicle on a long down incline. The SEMAS controller and control systems of this disclosure are designed to optimize the energy balancing for the vehicle and to make the most effective use of this significant energy recapture process. This advantage of SEMAS is equally attributable to the management of a fleet of vehicles.

As has been explained herein, the present disclosure provides a series of interlinked intelligent modules that together deliver improved vehicle performance and energy management to minimize TCO.

The SEMAS modelling suite contains software representations of all the vehicle subsystems the route, load and environment in the form of a an high-fidelity model (not shown) capable of running simulations of the vehicle across an large number of possible use cases. This modelling suite is used to develop the vehicle, optimises the size of power train sub systems for a given duty cycle and demonstrates an optimised control regime. This modelling suite also has tools to run the model against simulated drive cycles, industry standard drive cycles, idealised drive cycles and end user defined drive cycles. It also allows simulation of the vehicle performance at detailed subs system level and testing against real-world map data that contain a terrain profile, that can be generated from maps or from on board sensors collecting and analysing data while the vehicle is being driven along a particular route.

Once the variables and controls are established using the modelling data, for a specific range of end user requirements an abstraction of the whole vehicle model is coded into the SEMAS controller 110. It is important to use an abstraction which is sufficiently simple that numerical calculations are fast and reliable, for the actual numerical control algorithms. The generation of the design model, based on the full simulation model, or one of its versions, is therefore an important task. The simulation facility to be produced will allow the design model to be compared against the full high-fidelity model.

The disclosure provides for a simulation module which provides a functional representation of a vehicle, and in particular a hybrid fuel cell vehicle. The simulation module includes, at least, elements that model one or more of the following: thermal management; the fuel cell sub-system fueled with hydrogen; fuel cell BoP sub systems; the high voltage DC-DC converter; the HVAC subs-system; the power distribution sub-system; the PDU and powertrain controller; the energy storage sub-system; the high voltage battery; the E-drive subsystem; the inverter; the e-axle; the hydrogen tanks; the hydrogen supply system; the hydrogen refuelling; the hydrogen de-fueling; the parasitic loads (the energy demand from the balance of plant, BoP for example, fans, pumps, electric PAS, electric brakes); the cabin heater; e-stop; the low voltage battery; and the axle-wheel-tyre sub-system, cargo management characteristics. Other operational factors that may be relevant, such as “cold/freeze” stop/start (preparing the fuel cells for a shutdown prior to exposure to ambient conditions below 0 degrees Celsius can greatly facilitate cold/freeze start-up); “regenerative braking”, and fuel cell thermal management (as opposed to just cooling) can also be included.

The simulation model of the SEMAS controller and related control system could also be implemented at the powertrain level, ahead of including the vehicle level parameters. The simulation model can advantageously make various assumptions, for example, consistency of subsystem performance from one example to another and hence the fidelity of the model). The axles and wheels are assumed to be stiff, i.e., no flexing in either the linear or rotation directions. The tyres may be assumed to be flexible, with diameters and rolling resistances that may be affected by tyre pressure, cargo mass and dimensions, and potentially other factors.

It can also be assumed for the construction of the simulation model that the rear wheel positions and orientation (in the forward and vertical directions) relative to the vehicle body are fixed. That is, vehicle suspension and flexing of axles in any direction can be omitted from the model, for a given iteration.

It can also be assumed that there is slip between tyre and road surface, and that the effects of steering the front wheels on rolling resistance, for example, can be ignored, for a given iteration. Meanwhile, the simulation model can advantageously take account of the effect of vehicle load on (effective) wheel/tyre diameter and (rolling resistance) torque.

For a given iteration of the simulation model, the vehicle body may be modelled as a rigid system with a kinematic relationship between the rear wheel (rotational) speeds and the body. Only motion in the forward/backward (or ‘surge’) direction of the vehicle body is considered. Thus, only the average (rear) wheel speed is derived.

For a given iteration of the model, one can advantageously assume that linear motions in the vehicle body's sideways and vertical directions (‘sway’ and ‘heave’) and rotary motions in all three directions or axes (‘roll’, ‘pitch’ and ‘yaw’) are zero.

Iterations of the simulation model can consider the following parameters: vehicle dimensions, including wheelbase and track width; vehicle mass; vehicle centre of gravity (CoG) and/or cargo load (mass) distribution over wheels (on front and/or rear axles).

A 3D iteration of the simulation model can be provided which models the weight distribution and accounts for dynamic loads and the rotary motions of ‘roll’, ‘pitch’ and ‘yaw’.

The low voltage battery sub-system can also be included in a given iteration of the model. This comprises various low voltage components that draw power from the power supply unit, such as, for example, lights, windshield wipers, HVAC and entertainment systems.

The SEMAS controller and related control system of the present disclosure thus provide a multivariant optimization model for controlling and optimizing the operation of a hybrid fuel cell vehicle, in particular a commercial fuel cell vehicle such as an LGV or MGV or HGV. The multivariant optimization model may combine a-priori data such as route and cargo load, with a model predictive control (MPC) approach. MPC is a method of modelling the behaviour of dynamic systems. MPC models predict the change in a set of dependent variables of the modelled system that will be caused by changes in a set of independent variables.

A high-fidelity simulation model can provide the basis for an energy management system (EMS). The EMS control elements of the controller 902 can be tuned to optimize the performance of the vehicle 700 given the specifications and limitations on vehicle powertrain sub-systems.

Using extensive model-based design, the system can then include dynamic customization of the EMS for each individual drive, cargo load and journey case. This is achieved by adjusting control system parameters using a form of self-adaption based on a mixture of deterministic rules and machine learning. This form of model based dynamic multivariate analysis and control system optimization analyses the sensitivity of the simulation models to all is constituent variables including the specific use case.

This results in a high-fidelity model driven controller switch dynamically adjusting the subsystem settings that best meet the prevailing performance requirements while also satisfying the powertrain subsystem constraints.

The use of MPC with electrically driven powertrains having multiple power sources, as is the case in a hybrid FCEV, more specifically a commercial vehicle, dramatically improves fuel efficiency, and powertrain sub system durability, while delivering an acceptable level of vehicle performance for a specific load carrying capacity and required journey time. The various trade-offs are represented in the model embedded within the controller as parametrized cost functions, which are used to achieve the drive mode selected. The simulation is used for model-based design, which allows the selection of different components for the required range of drive modes and duty cycles of the vehicle.

Once the components of the powertrain are selected and sized, then these component parts of the model are updated with the multivariant parameters of the selected components to provide a high-fidelity model which accurately reflects the specifications and operating characteristics of the selected components.

In a further iteration of the MPC algorithm design, a candidate MPC algorithm, in its unconstrained and constrained forms, is derived and included in the model. Also, a cost function is defined which incorporates the main requirements and enables the optimization of energy considering such factors as fuel cell and ESS degradation. Also, a cost function is defined that assigns a value to the micro-degradation. This is derived from the expected cycle life and the rate at which these cycles are being used for the proposed route segment. (For example, if the ESS life is x cycles and the replacement cost is Y then the cost of cycle is simply Y/x) this can be compared with the cost of the fuel expended to avoid that transient cycle on the ESS on a least cost basis.) In practice the cost function will take account of part cycle costs derived using a standard technique such as rainfall analysis (typically used to aggregate fatigue part cycles).

The actual performance achieved is recorded in the on board data logging module and these detailed data sets can be used to validate and refine the high fidelity simulation in the SEMAS software suite. The resultant analysis is then used to tune the abstracted model in the controller and the decision algorithms to drive improvement in the MPC controller performance and calibration to obtain and demonstrate the results achievable.

As experience of operating fuel cell vehicles, and in particularly a fuel cell commercial vehicles, improves over time, the simulation results are developed to provide different performance and degradation measures of the electro-chemical powertrain sub systems (Fuel Cell and Battery) under different driving conditions and driving cycles to a fleet manager who can then make decisions on the trade-offs between performance and the projected life of the fuel cell vehicle.

This takes some of the responsibility for setting the drive modes away from the driver (who, in a commercial vehicle, may not always drive in the most efficient way) and passes this control to the fleet manager. This can help to ensure consistent performance even when different drivers use a vehicle, resulting is greater overall efficiency and a lower TCO for the fleet.

With the opportunity for multiple sensors reporting on the various energy management sub-system there is then an opportunity for the SEMAS controller and related control systems to learn how these interact within a vehicle route and dynamically adjust the control algorithm to offer the end users various operating modes, for example to optimize fuel efficiency, to ensure maximum energy efficiency from the powertrain, or to maximize the useful life of fuel cell and energy storage sub-systems.

The SEMAS controller 110 may offer a range of end user modes that may be selectively made available to the driver depending on the end user (and/or fleet owner) preferences. This would include parameters such as implementations of speed limiter, acceleration limiter, or life extension settings. The SEMAS controller 110 may also receive a-priori information from global satellite navigation systems such as GPS, and proposed routing data, so as to dynamically adjust controls that manage the rate of fuel, more specifically hydrogen, consumption to ensure that the vehicle is capable of reaching the next planned refilling station.

The SEMAS controller 110 may also implement a control algorithm to limit ramp rate (the rate at which the fuel cell output changes in response to a request to provide more or less power output). This is done to reduce thermal stresses on critical energy sub-system components, by prioritising operation within the power demand cycle that results in the least damage to these valued powertrain components.

The SEMAS controller 110 may also interrogate the status and rate of change of status of various variables, including one or more of:
Power flows in the various sub-systems, DC/DC convertors and the two-way DC/AC controller of the power axle
Vehicle speed and driver demand for change in speed—(accelerating or braking)
Temperature in fuel cell stack,
Battery temperatures
Current hydrogen inventory (the hydrogen fuel gauge)
Current battery SOC
Current ramp rate on FC change of power output
Water management in the fuel cell sub-system

The SEMAS controller 110 may also take account of route data (with full terrain maps), weather and traffic data.

In one exemplary embodiment, the following control modes may be provided:

| Mode | | |
|---|---|---|
| No | Mode Name | Description |
| 1 | Performance | Used for high cargo loads and short journeys where |
| | | responsiveness of the powertrain and maximum |
| | | performance are the desired criteria. This mode uses the |
| | | full permitted range of the State of Charge (SOC) of the |
| | | battery and the full ramp rates available from the fuel cell |
| | | (FC) and battery. |
| 2 | Balanced | Balanced is the optimum mode for normal duty, balancing |
| | | FC and energy storage systems life, performance, range, |
| | | and fuel efficiency for the optimum driving experience. |
| 2 | Life | An eco mode which minimizes FC and battery cycling to |
| | Extension | achieve minimum impact on number of cycles of these |
| | | powertrain sub-systems. This mode looks at the interaction |
| | | between power demand and the terrain, while seeking to |
| | | minimize rapid transient power on the fuel cell sub-system |
| | | and energy storage sub-system cycling. The high and low |
| | | power/SOC limits of the FC and energy storage operation |
| | | are scaled back to optimum life settings and the |
| | | elimination of short cycling of these powertrain sub- |
| | | systems. |
| 3 | Fuel | An eco mode based on achieving maximum fuel efficiency |
| | Efficiency | based on the cargo load and the selected route. The |
| | | algorithm here seeks to meet the speed request, while |
| | | operating the fuel cell sub-system within its most efficient |
| | | range. |
| 4 | Dynamic | An emergency mode where the vehicle is delayed or misses |
| | Range | a fuel stop and places it into an extreme eco mode to |
| | Adjust | ensure the vehicle can reach the destination. This has the |
| | | most extreme effect on performance. This mode uses a |
| | | dynamic speed limiter to reduce drag, reduce acceleration, |
| | | and maximize coasting potential while taking the terrain |
| | | into account. The severity of the performance hit will |
| | | depend on the remaining range. |
| 5 | Range | An extreme eco mode where the powertrain performance |
| | Extend | is limited to ensure that the vehicle achieves the required |
| | | range to next refueling. Range extend mode is speed and |
| | | acceleration limiting as necessary to achieve the extended |
| | | range. |
| 6 | Driver | This mode provides the driver with advice on fuel efficiency |
| | Assist | and how driver behavior can be improved, while not |
| | | overriding the driver's control. This function can also |
| | | provide feedback to driver on current performance and |
| | | make and suggestions for selecting a controlled drive mode |
| | | and showing predicted effect on performance, fuel, most |
| | | often hydrogen, consumption and range. |

It will be appreciated that further drive modes may be provided, and a given hybrid fuel cell vehicle does not have to provide all these modes. For example, a “cold/freeze” start-up/shutdown mode based on ambient temperature could be provided, which can resolve issues with ice or other frozen matter anywhere in the system. The SEMAS controller and control systems of this disclosure are designed to optimize the energy balancing of the vehicle and provide real-time feedback to the driver and powertrain sub-systems on the optimum driving modes required to achieve the end user's desired fuel efficiency and range. This advantage of SEMAS is equally attributable to the management of a fleet of vehicles.

The SEMAS controller (110) can be structured into three control layers logically connected to share information and one that can adapt the control policy to achieve the required fuel cell vehicle performance. This may for example comprise the following control modules:

EMS Based on MPC.

This is the model-based control layer which computes the optimal power flow for vehicle powertrain sub-systems by iteratively solving a constrained optimization problem using available data sources and apply these parameters to the embedded model of the vehicle in this layer.

This layer can process the data using a set of algorithms (developed according to model-based or data-driven methods) and is able to provide an effective prediction of signals against target-set points.

The MPC control layer then sends control system requests to the subsystem controllers to adapt the sub-systems state in response to predicted power demands. Balancing energy supply, and demand and taking into account the efficiency map and restrictions in operating in some parts of the operating curve, the MPC controller will seek to optimize fuel utilization, and minimize transient events seen by the fuel cell or battery systems to lower degradation rates.

Data Interface Module (DIM).

This control layer services the MPC model control layer by providing the model parameters from the on-board data sources. These are the data carrying and processing modules 120, 150, 160 and 170; these provide status information from the various sub systems and calculated parameters including, for example, the current state of the subsystems (such as battery state of charge, remaining fuel and fuel cell power output) as well as the route, and terrain map, traffic conditions and the target velocity, as calculated in the driver module. The DIM module also combines calculated parameters from the embedded model, such as, predicted energy required to complete the journey, with external data sources which include route data, alternative routes, current traffic flows, temperature, weather etc. to bring them to a common data time step.

The DIM layer also provides a-priori information (140), which is available at the commencement of the journey. This will include for example trailer dimensions, drag factor, vehicle weight, and cargo load.

For example, by knowing how the cargo load may change in journey, (due to cargo drop offs and pick-ups) the vehicle dynamics module can be updated at these set points to allow adaptation of the predicted energy demand in response to known terrain and hence power demands events for the remaining journey.

SEMAS Cloud Module.

This control layer looks after the inputs and outputs to the system datalogging module, that module can upload and download information through onboard telematics. It can also access the SEMAS Cloud to access the overall set of available information to compute a set of SEMAS control system parameters that reflect the expected scenario the fuel cell vehicle will face over the planned route. Information processing on the cloud servers can access bigger data sets than are available on the vehicle and can use AI, pattern recognition, machine learning and other more computationally intensive techniques to derive further improvements in performance across the whole route (and even recommend alternative least cost routing accessing third party data not available to the vehicle). Performance improvement will include fuel efficiency, journey time and durability of the fuel cell and battery sub-systems. An algorithm combining AI and model-based techniques can compute the most suitable control parameters to increase the performance of the fuel cell vehicle over the full path to be followed during the trip.

Design of the Baseline EMS Policy.

The controller will also hold a baseline “simple” control policy to be designed according to a rule-based approach to provide ‘fall-back’ control. Wherein ‘fall-back’ control is a term used in the art to describe an aspect of safety as to what the SEMAS controller does when confused, loses sensor inputs, or has conflicting objectives.

Furthermore, the a priori information may comprise one or more of the following:

| Data Set | Source | Data Set Description |
|---|---|---|
| Route | GPS - Route selected - or | Geolocation mapping data |
| | recalculated | |
| Terrain Map | GPS Elevation Data/SEMAS | Distance gradient map of selected route |
| | Cloud route gradient | |
| | database, generated by | |
| | collecting data from the fleet | |
| | of operating vehicles. | |
| Traffic Profile | Real Time traffic information - | |
| | Database | |
| Speed profile | Predicted speed profile on | Calculated from route, traffic database |
| | selected route | drive mode and constraints model |
| Tractor Gross | A declared constant | GVW of Tractor when loaded including the |
| Vehicle Weight | | drive but excluding the trailer |
| (GVW) | | |
| Plated Weight | A declared constant | Maximum permitted GVW of tractor and |
| | | loaded trailer combined |
| Trailer Tare | Trailer specification | Trailer unladen weight |
| weight | | |
| Load | Operator input or measured | Trailer net load |
| Driven Axle | Calculated | Weight on driven axle, when loaded trailer |
| weight | | attached |
| Rolling | Calculated from vehicle | |
| resistance | weight data | |
| Trailer Height | Trailer specification or Trailer | |
| | RFID (Radio Frequency ID) | |
| Trailer length | Trailer specification or Trailer | |
| | RFID | |
| Trailer Drag | Factor associated with trailer | |
| factor | shape and any drag reduction | |
| | devices fitted | |
| Dynamic Drag | | Drag factor of tractor unit and trailer |
| Factor | | combined |
| Average | Weather data combined with | |
| Headwind | route data | |
| Ambient | Route ambient temperature - | |
| temperature | initially a constant from | |
| | weather data | |
| Available | VHG - see separate | Usable hydrogen on board. As measured on |
| hydrogen | description | VHG - Virtual Hydrogen Gauge |

Again, it will be appreciated that the SEMAS controller and related control systems 100 may employ further a priori parameters and does not have to use all the parameters listed in the table above; this table is provided as an exemplary embodiment only.

For example, the a-priori information may include route data with high fidelity gradient data from mapping and historical travel over the route. Furthermore, the SEMAS controller and related control systems 100 may be provided with both GPS and inertial navigation sensors to systematically refine the accuracy of the available route map data. The SEMAS system 100 may be provided with a library of standard drive cycles, which may be those used for vehicle tests such as New European Drive Cycle (NEDC), the Artemis series, a light duty vehicle (LDV) or a Worldwide harmonized Light Vehicles (WLTC) Test Cycle.

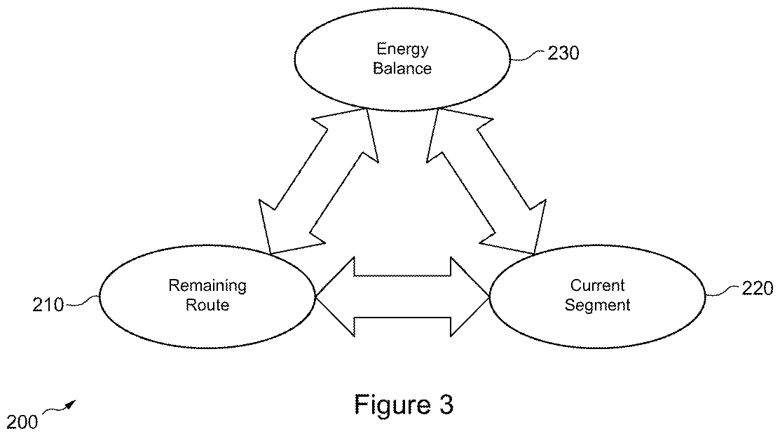

FIG. 3 shows the three software modules in the model-based control layer that forms part of the SEMAS controller 110. which computes the optimal power flow. These software modules process the data using an abstracted model of the vehicle with accurate sub-system performance maps that may be algorithmically generated or using a simple data-driven method such as a look-up table.

These three module functions are interconnected.

Remaining Route Module 210

Before the journey, the remaining route (RR) module receives the planned route data, and uses the a-priori database, to undertake a detailed simulation that takes account of the vehicle cargo load, fuel loading required to complete the designated drive profile and terrain map to determine the available operating margins.

A key variable that is set in this module is the “cargo profile”, which includes, for example, the following factors: weight, type, delivery schedule, environmental requirements (for example, cooling). These factors provide a significant contribution to the calculated energy profile (overall energy demand of the vehicle) of the route. The variation in cargo type, variable payload mass and dimensions, and other energy demands is a specific challenge for efficient commercial vehicle operation. By assessing uncertainties and errors the remaining route (RR) module will advise if the route can be achieved with the current fuel inventory at an acceptable margin, it may then suggest an alternative route, alternative drive profile and/or an intermediate refuelling stop. From the route simulation the module will identify key set points and split the route into drive segments. The set-point target parameters will be passed to the Current Segment (CS) module 220.

At each set point the RR module 210 will re-run the simulation on the remaining route and if necessary, update the set-point target parameters. The RR module 210 will present information to the driver through the dashboard Human Machine Interface (HMI).

Existing systems that present similar data, such as Satellite Navigation systems, which show an estimated arrival time and distance to destination, a fuel gauge which shows fuel remaining and a range calculation that indicates the available range.

These systems are available with various degrees of sophistication and accuracy. The problem is that they do not define the uncertainties and use very simple algorithms, causing range anxiety as described below.

Current Segment Module 220

This module deals with adaptive energy management over the current segment and will react to prolonged transient events, such as acceleration from rest to speed, or anticipating significant large up or down gradients on the current segment. The CS module 220 takes the status and determines the strategy to deliver the target vehicle status, as required, at the next set-point. At the setpoint it reports the status to the RR module 210 which then re-calculates the available margins based on remaining route segment setpoints.

The CS module 220 can anticipate and calculate the available quantum of energy required to achieve the next set-point, then provides advise to the energy balance (EB) module 230 on the requisite state of charge so that maximum recovery of the available regenerative energy is made. This increases the overall efficiency of primary energy use and availability.

To maximise the life of the fuel cell it is preferable to limit the rate and the number of energy demand cycles to which the Fuel Cell is called upon to provide and to avoid rapid short cycling of power demand. This is especially important when the fuel cell is operating at peak power. The CS module 220 prepares a simulation of the projected power-demand time profile for that route segment together with projected net primary energy demand and the projected SOC of the energy storage system.

Energy Balance Module 230

The energy balance (EB) module 230 makes decisions about the short-term EB, looking at the energy available and the energy demanded by the drive module (see FIG. 2, element 150), then determines the best way to dynamically balance energy supply and demand. This decision-making process is a multi-variate optimisation problem, finding the optimum solution over several interconnected variables. These can include:
1. limits on ramp rates of the fuel cell sub-system and SOC of energy storage system(s)
2. thermal balance
3. working points based on the energy sub-systems efficiency maps.
4. least cost assessment, based on cost functions associated with each of the sub-systems.
5. driver experience and expectation.

For example, a large power demand transient might be partially met by the energy storage system, underpinned by a small increase in the power output from the fuel cell sub-system, and balanced off by a power demand side reduction. The unmet demand could, for example, result in a lower acceleration than requested by the drive profile.

The EB module 230 then determines best fit to meet that power use profile for the vehicle for a given route segment. The rate of change of power in the power profile is determined as the available energy from both the fuel cell (FC) and the energy storage system. Where meeting the demanded power profile will push the powertrain sub-systems into higher than desired power transients, or where the total energy needed to meet a projected power transient will exceed the available energy from the fuel onboard, then the EB module 230 will function to smooth out power delivery. EB module 230 undertakes this power demand side intervention to avoid a step-change in power output when the fuel cell is at or close to its limit on peak power and the energy storage system has fallen to a level where it is unable to provide sufficient motive power assist.

This power smoothing is essential because the alternative is to follow the power demand profile by ramping up the FC power output to the maximum allowable under the current journey criteria, while delivering as much power as possible from the energy storage system. Once the energy system is exhausted the residual power demand will have to come from fuel cell sub-system. This is a very undesirable state as the driver would experience a step fall in available power and irreversible damage to the fuel cell stack could occur.

The situation as described above could occur where the driver (or velocity profile ref 150) is requesting that the vehicle accelerate up a long incline at full cargo load and power demand.

In contrast, for a conventional Internal Combustion (IC) engine vehicle, when the power demand due to acceleration exceeds the available power of the engine, the vehicle simply does not meet the acceleration demand and proceeds at a slower speed than requested up the entire incline.

However, although the ICE vehicle, in this scenario, is hitting a power limitation it is not hitting any energy limitations. The total energy available from the ICE engine is only limited by the on-board fuel. This is not the case with a hybrid fuel cell powertrain, where the peak power is supplied by a combination of the FC and energy storage sub-systems. The total energy output of the FC is limited by the available fuel, but the energy storage is limited by its available capacity, which in the scenario described is unable to be replenished by regenerative braking.

Appropriate sizing of the energy storage system on a hybrid fuel cell vehicle is an unavoidable compromise and is generally matched to the anticipated power profiles that the vehicle will experience. This is especially true for hybrid fuel cell commercial vehicles such as a LGV or MGV or HGV. These types of vehicles can carry a larger quantity and varied types of energy storage devices able to provide greater levels of propulsion assistance, while also taking advantage of the large quantities of energy to be recouped through regenerative braking available from such high mass, cargo carrying, vehicles.

The SEMAS controller and control systems of this disclosure are especially designed to optimize the energy balancing for hybrid fuel cell commercial vehicles, in all operation modes. SEMAS has been designed to manage powertrain energy balancing for a complex array of energy propulsion and energy storage sub-systems to ensure that such vehicle achieve excellent fuel economy and desired range at a low TCO for end users. This advantage of SEMAS is equally attributable to the management of a fleet of vehicles.

A key focus has been the TCO, a critical metric for the fleet operator as it defines the most significant cost to provide a goods haulage service. As noted above this can be measured on a cost per tonne-km basis. The TCO comprises both fixed and variable costs. Some of these are roughly similar for both existing diesel powertrain and hybrid fuel cell powertrain options and as such do not need to be considered. For example, the cost of drivers and tyres are going to be similar for similar use cases.

However, some factors that will affect the TCO are the vehicle tare weight vs cargo load within the same GVW and refuelling time against driver time availability. The principal components driving TCO differences for diesel versus hybrid fuel cell commercial vehicles are capital cost of the vehicle, the operation and maintenance costs (including fuel cost) and vehicle life. Capital cost differences are largely driven by the unit price of the hybrid fuel cell powertrain sub-systems, balance of components being similar between different powertrain variants of the same vehicle class.

Fuel efficiency for a given powertrain will depend on the detailed design and specification but is subject to large variation depending on details of the vehicle use. This is especially true of diesel commercial vehicles where the same vehicle can deliver effective fuel consumptions in the 4.5-12 mpg (miles per gallon) range depending on the load, terrain, and driver.

Operational fuel costs are also driven by the fuel commodity cost, which reflects energy costs generally. However, for Battery Electric Vehicles (BEV) and hybrid fuel cell vehicles, there is a very variable fuel cost depending on the infrastructure cost to get the fuel to the vehicle, taxation policy for the fuel and the means by which electricity is produced to recharge the BEV.

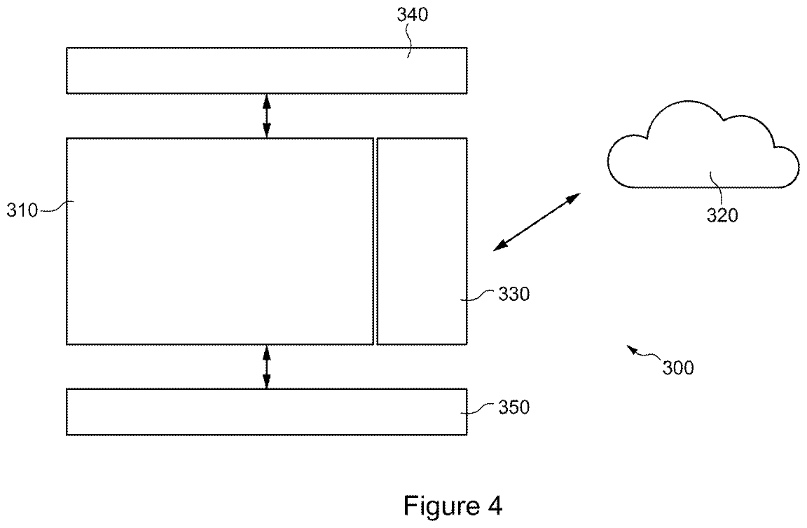

The SEMAS controller hardware architecture is illustrated in FIG. 4. SEMAS controller 310, which is an on-board supervisory control module with sufficient processing power and interconnectivity that interrogates and interacts with the fuel cell sub-system ECU, BMS, PEMD controller, thermal management system and dynamically adjusts power flows between all the powertrain and ancillary equipment depending on vehicle cargo load and road conditions.

SEMAS Cloud 320 allows for building on historical performance data and provides for data analytics to allow the use of more complex adaptive methods, and data processing extending the SEMAS control system capabilities. The SEMAS Cloud 320 further comprises an online database (not shown) that receives data from individual vehicles, provides analyses and Fleet Management Services. It also holds libraries of a-prior route and mapping data and provides data mining and AI (Artificial Intelligence) opportunities.

Also shown is a SEMAS telematics module 330, which can be integrated into the SEMAS controller 310 or serve as a stand-alone module. This module 330 provides connectivity and connects the SEMAS controller to the SEMAS Cloud data bases 320. The telematics module 330 can store sending and receiving route segment data and time series data from the subs systems controller and on-board sensors systems. The SEMAS telematics module 330 is an on-board data logger and connectivity module that connects SEMAS controller 310 to the SEMAS Cloud 320.

SEMAS Sensor suite 340—the SEMAS control system of the present disclosure requires access to a suite of sensors to provide basic functionality. Depending on the sophistication of the vehicle model and the inputs required it will also be able to use a wider range of sensors, to provide enhanced functionality and specific embodiments of the derivative applications. The totality of vehicle sensors that are interrogated and used by the SEMAS control system of this disclosure. Some of them are provided for other purposes and the SEMAS control system integrates the sub system controller data to understand their status and limits on operations. For example, the hydrogen storage tanks use pressure sensor for safety alarm and to provide an estimate of hydrogen remaining, based on a volume calculation, while the Fuel Cell controller monitors voltage and current. These data provide an accurate signal that represents the output of the fuel cell subsystem. The FC subsystem will also have a temperature sensor, by using the SEMAS model of the fuel cell (perhaps via a lookup table of efficiency data), the vehicle operations can be optimised. At specific operating temperatures then the hydrogen input can be calculated. SEMAS can then integrate the hydrogen input flow rate against time to derive a hydrogen used metric and correlate this with the hydrogen pressure sensor to derive a more accurate estimate of the hydrogen remaining. Similarly, a key parameter in the Newtonian model of the vehicle is the vehicle mass.

By integrating the power (voltage and current input to the motor system and integrating the drive train gear status, then the power output to the wheels can be calculated and this together with a measure of the vehicle acceleration (either from the interrogating the velocity sensor or by direct measurement from an on board accelerometer) then the vehicle mass can be computed and this parameter fed into the vehicle dynamic model. If the vehicle loads or unloads cargo, then this simple algorithm can be used to update the vehicle mass. The algorithm that does this may also include weather data to work out if the road is wet and make allowances for tire slippage.

SEMAS Algorithms 350—one aspect of the SEMAS control system forms a model-based dynamic multivariate analysis get and control system optimisation. The aim is to produce a high-fidelity model of the vehicle operating characteristics, its specific set-up for the selected route and the dynamic route data, in sufficient fidelity to dynamically explore the entire design space. This will allow the SEMAS control system to arrive at an instantaneous set of variable settings that best meet the prevailing performance requirements of the vehicle while satisfying the defined energy sub-system constraints. Depending on the target operational criteria and drive mode for the vehicle, then these data are adapted by the SEMAS control system to provide additional drive modes, as needed to achieve an optimum energy balance over the vehicle journey.

It will be appreciated that in commercial vehicles the inertial mass of the vehicle and momentum is a mechanical store of energy. This presents the designer of the powertrain with options on the relative sizes of the fuel cell sub-system and the energy storage sub-system together with the selected control algorithm on the SEMAS system controller which selects how much power needs to be supplied by each of the sub-systems to meet the instantaneous power demand of the vehicle.

The SEMAS controller and related control system of the present disclosure can select operating modes depending on the driver's performance requirements for the vehicle, in addition these parameters are dynamically adjusted by SEMAS depending on the historical and predicted energy demand profile for the traffic conditions, fuel supply remaining and route profile.

The SEMAS controller and related control system of the present disclosure also makes use of a-priori information from GPS and proposed routing data and dynamically adjust controls and rate of fuel consumption to ensure that the vehicle can reach the next set-point and if requested, complete the route to the next filling station. By dynamically adjusting the performance at each of the route segment setpoints, as defined by SEMAS, the information available to the driver will greatly reduce and potentially eliminate range anxiety.

Range anxiety is a phenomenon, that has arisen with electric vehicles. This is due in part to the relatively lower range capabilities of BEVs but is additionally aggravated by inaccuracy in the remaining range prediction.

In general, the assessment of remaining range is taken from a State of Charge (SOC) algorithm, that then applies an estimated rate of energy consumption to predict the remaining range. Since this does not always consider any future variations in energy consumption due to traffic, terrain, weather conditions, or the consumption of parasitic loads due to environmental factors, the range predicted can suddenly drop. This inaccuracy or fluctuation in reported remaining range creates driver anxiety.

The SEMAS control algorithm of the present discloser can also be deployed to limit ramp rate (the rate at which the fuel cell sub-system responses to a change request in power output). This is done to:
a) reduce thermal stresses on powertrain sub-systems,
b) avoid short energy cycling for the ESS and power demand transients that can lead to higher degradation of the fuel cell sub-system,
c) prioritise energy balancing to maximize efficiency from the powertrain sub-systems.

The EB module (of FIG. 3) is the part of the SEMAS control system that interrogates the status and implications of the immediate projected demand profile to assess the best way to meet the change in power demand by managing:
Energy balancing in the various powertrain sub-systems, DC/DC convertors and the two-way DC/AC controller of the power axle.
Vehicle speed and modifications to driver demand for change in speed—(accelerating or braking).
Temperature of fuel cell sub-system.
ESS temperatures.

All while taking account of:
a) Current fuel inventory (for example, the hydrogen fuel gauge)
b) Current battery SOC
c) Current ramp rate on FC change of power output

The SEMAS Cloud 320 is designed to use machine learning to compare the progress over the current route segment with historical progress over the same route modified by differences in vehicle type, age, and cargo load.

This provides extremely valuable data for the end user and fleet manager of commercial vehicles which often repeat the same route multiple times per week. This data gathering and analysis process allow the SEMAS control system to learn how to optimise control of the powertrain sub-systems to meet driver demands while minimising fuel consumption.

The context in which a vehicle 400 of the present disclosure can operate is shown in FIG. 5. In a given land mass 500, a vehicle 400 may journey between termini 502, with the option of stopping along the way at refuelling stations 504, as well as for the uploading, or offloading of cargo, for example. The present disclosure can provide a platform 506 for fleet management and control which can communicate remotely with the vehicle 400 and can optionally communicate with the termini 502 and fueling stations 504, as well as to location points of cargo upload or offload, for example. This platform receives detailed data from each vehicle about the state of its subsystems, the success or otherwise of the SEMAS controller in meeting the defined set points. The data set to the platform also includes details of the subsystem states together with the route data as processed by the controller. The platform 506 will be able to use this rich (big data) sets to run more advanced models, and analysis, together with machine learning to update the vehicle a-priori information stores and provide information about operational status of all the vehicles in the fleet. This level of telematics will also enable planned preventative maintenance and allows the use of alternative sales models, based on a cost per mile and provide diagnostic data to support product guarantees. The platform 506 may also exchange data with one or more external data sources 508, as will be discussed in more detail below.

A fleet of vehicles 400 may be managed in multiple regions by the platform 506. The communication and exchange of data between the platform 506 and the vehicles 400 may be by means of wireless communications including the use of the internet and web technologies, as such, the platform 506 can be physically located anywhere. The platform 506 is illustrated for convenience as a monolithic block, although it is to be appreciated that a distributed architecture may also be employed, with component parts of the platform 506 being physically implemented in a plurality of different locations on different servers or peer to peer machines.

The communications between the platform 506 and the vehicles 400 may make use of the communications interfaces 404 of each vehicle 400, which may involve wireless communications technologies or alternatively could be achieved by manually copying data stored locally at a data storage device provided at the vehicle 400. Docking stations (not shown) can be provided at one of the termini 502, the fueling stations 504 or other locations at which the vehicle stops.

As mentioned above, the disclosure may apply generally to any type of vehicle but has particular relevance to those which are commercial vehicles including LGVs, MGVs and HGVs. The vehicles 400 of the disclosure may include any type of fuel or powertrain system, but in some embodiments, the invention has utility for hybrid fuel cell electric vehicles, which comprise a fuel cell sub-system and energy storage device(s). As alternative technologies for Fuel Cells and Battery systems become available with different performance characteristics then the models and the appropriate cost functions can be updated. Examples include different battery chemistries, Solid Oxide Fuel Cells, and battery/supercapacitors hybrids.

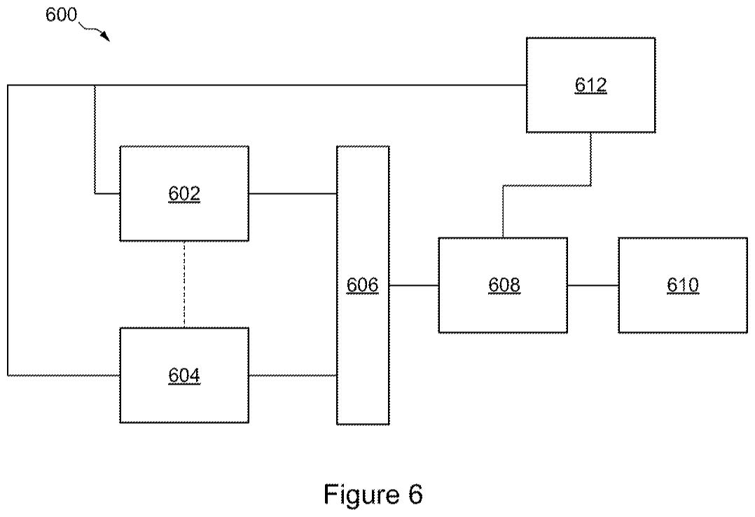

A powertrain 600 for a vehicle of the present disclosure is illustrated in FIG. 6. Here, a fuel cell 602 and a battery 604 both provide input to a direct current bus (DC bus) 606, which provides power for a motor unit 608 which in turn drives a differential 610 coupled to the wheels of the vehicle of the description (see FIGS. 4 and 5). Power can be supplied via the DC bus 606 from either the fuel cell sub-system 602 or the energy storage sub-system 604. It is also possible for the fuel cell 602 to provide power to charge the energy storage 604, as indicated by the dashed line in FIG. 6.

The fuel cell sub-system 602 combines fuel and a source of oxygen in an electrochemical reaction to produce energy, water, and waste heat. In a preferred embodiment, the fuel cell sub-system 602 is a hydrogen-fueled fuel cell sub-system which combines hydrogen with air, producing water (hydrogen dioxide) and heat as the only by-products. The hydrogen is supplied by the vehicle's hydrogen fuel tanks (not shown), which will be discussed in more detail below. The vehicle powertrain 600 may also be provided with a system controller 612, which provide which is in communication with and managed by the SEMAS controller and related control system, that may be in communication with the fuel cell sub-system 602 and ESS 604 and can provide control signals to motor unit 508 for the management of energy supply to the drivetrain of the fuel cell electric vehicle (FCEV). It is also noted that the FCEV may include other power sources such as supercapacitors, the ESS 604 may comprise a bank of cells, and that a plurality of fuel tanks, more specifically hydrogen fuel tanks, which can be coupled with a vehicle for providing fuel for the fuel cell sub-system 602.

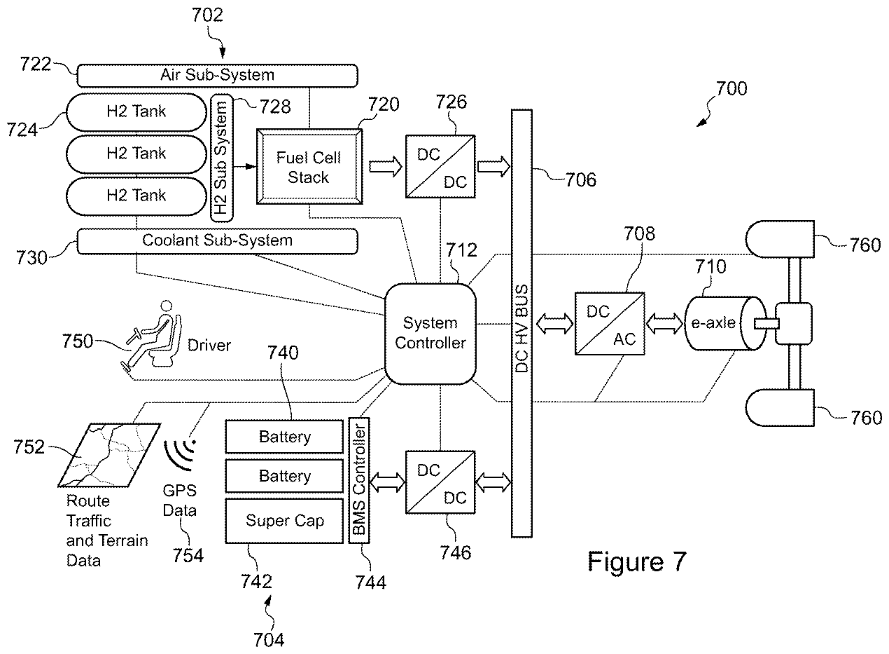

FIG. 7 illustrates a schematic of a powertrain and the SEMAS Controller control system 700 for a vehicle in accordance with an embodiment of the disclosure. A fuel cell sub-system 702 and ESS 704 supply power to a DC bus 706 which drives an e-axle 710 via a DC-AC converter 708. The physical SEMAS controller 712 which contains a software model of the control system 700.

Meanwhile, the ESS 704 may comprise one or more battery cells 740 and supplementary energy storage components such as a supercapacitor 742. The battery cells 740 are managed by a battery management system controller 744 communicatively coupled with the DC bus 706 via a DC-DC converter 746.

Within a hybrid FCEV, the electrochemical based sub systems (the fuel cell sub-system 702 and the ESS 704) will suffer degradation in use as the electrochemically-active constituents age. To achieve maximum life of the vehicle powertrain (and hence a lower TCO), both of 702 and 704 should ideally be operated within cycle and ramp rates as controlled by the SEMAS controller and related control system, and ancillary systems (such as the thermal plant), fuel supply and environmental conditions should be kept within defined limits, as controlled by SEMAS. These limits need to range from a start in sub-zero conditions, where both ESS 704 and the fuel cell sub-system 702 may require specialized start-up conditioning as determined and controlled by SEMAS to preheating, to operating in high environmental temperatures where additional stress is placed on the cooling systems.

The control system 712 acts to operate the electrochemical sub-systems as much as possible in their ideal operating regimes (for example at the points of highest efficiency and within charge and discharge limits, temperature dependent rates of change or short and longer term peak power handling. Similarly, the PEMD system will have thermal limitations that may be environmentally determined that provide short- and long-term peak outputs. Since the model in the SEMAS controller reflects these limits then the power profile demanded, and that predicted to be supplied, can be modified to achieve an energy balance that maintains all of the vehicle subsystems within their prescribed operating regimes.

The control system 700 of the disclosure interrogates the status of the sub-systems taking into account external factors such as environmental and weather conditions, terrain, cargo maintenance and driver safety. The control system 700 then sends commands to the powertrain subsystems to set these to deliver optimum performance of the whole powertrain, over the next section of the route. Optimum is defined in terms of the trade-offs in delivered acceleration, required velocity, fuel efficiency and fuel cell and battery durability. as Additional factors are dictated by the optimization energy balancing algorithms as defined by the SEMAS controller and control system of the present disclosure.

The SEMAS controller 712 can interrogate the ESS controller 744 as to the current state of charge and the limits on each of the ESS subsystems. SEMAS then instructs the ESS controller what settings it needs to have based on its predictive model of power demand and how this is to be balanced between FC and ESS sub systems. For some duty cycles the ESS 704 can be made up of different energy storage technologies. These may include the use of supercapacitors 742 coupled with high and low-rate battery sub-systems.

The ESS sub-system controller 744 can also adjust the power flows in the ESS sub-system 704 to ensure that, for example, the high-rate components of the ESS sub-system 704 which may have a shorter life can be swapped out, while the other energy storage components of the ESS 704 are protected from high charge and discharge rates.

The SEMAS controller 712 is communicatively coupled with the fuel cell sub-system 702, the ESS sub-system 704 and each of the DC-DC converters 726, 746. In addition, the SEMAS system controller 712 may comprise dedicated interfaces for each of the hydrogen tanks 724, the coolant sub-system 730, the fuel cell stack 720 and the battery management system controller 744. Effectively controlling/managing the hydrogen tanks can lead to: enhanced safety of operation; maximum fuel economy; ease of vehicle operation during acceleration; deceleration and terrain gradient and changing weather events; and provide fuel for non-operational situations related to overall driver experience/safety.

Furthermore, the SEMAS controller 712 may receive inputs from a driver 750; from route, traffic, and terrain data 752; and from GPS data 754; along with other inputs as described herein.

The high voltage power distribution is illustrated in schematic form in FIG. 7. In this representation the power outputs of the Fuel Cell subsystem and ESS sub system are capable of independent operation through their own DC/DC convertors 726 and 746, respectively, to provide power to the drive motor and hence the wheels 760, through an DC/AC convertor 708. Power distribution and energy balance is achieved in the power distribution unit (labelled DV HV bus) 706. (Only two wheels are illustrated for clarity, but these may comprise front and/or rear wheels of a vehicle according to the chosen transmission system).

The e-axle 710 may comprise a motor generator set coupled with a mechanical drivetrain component to drive the wheels 760.

Both the fuel cell sub-system 702 and the energy storage sub-system 704 can operate independently or in combination to provide the peak power demand of the vehicle of the disclosure.

In addition, the ESS sub-system 704 may be charged during vehicle operation by either taking excess power from the fuel cell sub-system 702 when it is producing more than the vehicle requires at that point in time, or from the motor generator of the e-axle 710 when the vehicle of the disclosure is under deceleration or in braking mode.

The powertrain and SEMAS controller 712 may also manage reactant gas humidification and provide a water management system, as effective gas humification and water management are important for achieving maximum power efficiency across the polarization curve for the fuel cell sub-system 702, as well as durability of fuel cell stack 720. Another critical operational condition for the fuel cell sub-system 702 related to effective water management is cold/freeze start-up and shutdown. The SEMAS controller 712 may measure dew points or detection of humidification status to determine whether the control system 712 can ask for a power level change.

It will be appreciated for commercial vehicles that the large mass of the vehicle is in effect a mechanical store of energy. This presents the designer of the powertrain with options when deciding the relative sizes of the fuel cell system 702 and the ESS 704 together with the selected control algorithm for the SEMAS system controller 712 which selects how much power needs to be supplied by each of the sub-systems 702, 704 to meet the instantaneous power demand of the vehicle of the disclosure.

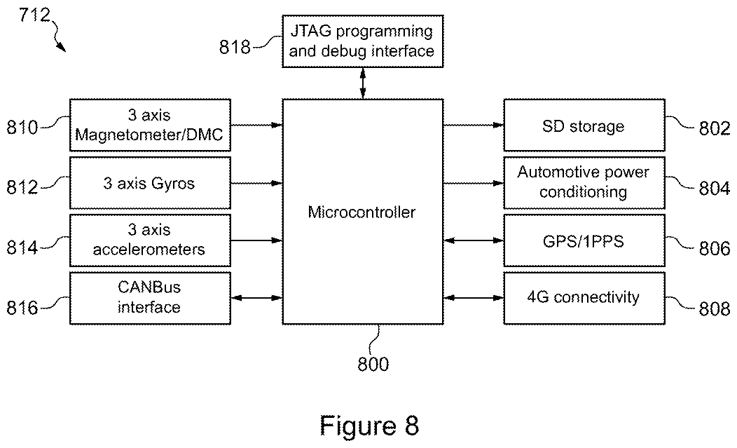

FIG. 8 illustrates a high-level architecture of a SEMAS controller 712 according to an embodiment of the disclosure. The SEMAS controller 712 may comprise a microcontroller 800 with a number of input/output ports which interact with a data storage 802 such as an SD (Secure Digital) card (as known in the art) or other type of memory (which may be removable). Other data which could be automatically logged to the SEMAS Cloud, includes automotive power conditioning 804, global navigation satellite system antenna 806, wireless telecoms connectivity 808, inputs for inertial measurement unit with components such as a magnetometer 810, gyroscope 812 and accelerometer 814, a CANbus or equivalent interface 816 for communication with other vehicle systems, and a programming interface 818 which may for example comprise a JTAG programming and debug interface 818.

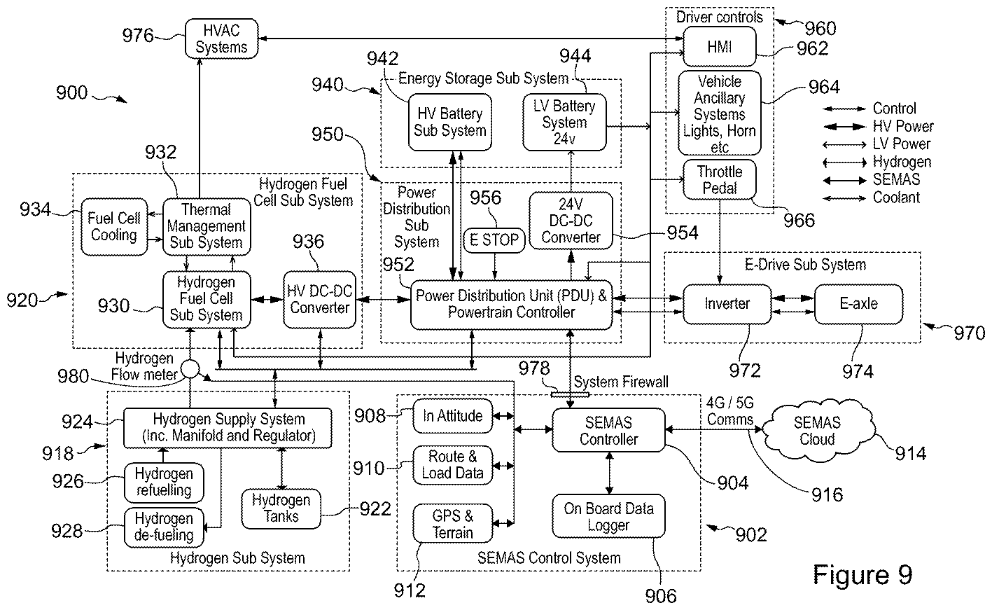

FIG. 9 illustrates further details of an exemplary vehicle architecture 900 containing similar sub-systems and being in line with that shown in FIG. 7. Here, SEMAS processing unit 904 is in a data logging mode and provides driver information, and predictive setting of the energy supply side adjusting FC power output and Battery SOC while vehicle velocity the control thereof remains with the accelerator connection to power distribution unit.

In this further detailed embodiment, the vehicle 900 is provided with the SEMAS control system 902 that comprises the SEMAS processing controller 904 and the SEMAS system data logger 906. An in-attitude input 908, a route and load data input 910, and GPS and terrain data input 912 provide data to the SEMAS controller 904 which also receives data from the hydrogen flow meter 980.

The controller 904 may be in communication with cloud services 914 (also part of 140) via a wireless telecom link 916. The cloud services 914 may comprise the platform 506 as shown in FIG. 5. A hydrogen fuel cell energy source comprises a hydrogen supply subsystem 918 and fuel cell subsystem 920. The hydrogen supply subsystem 918 comprises one or more hydrogen tanks 922 and a supply system 924, including a manifold and regulator. The hydrogen supply subsystem 918 can be fueled via a refuelling component 926 or defueled by a defueling component 928. The hydrogen fuel cell subsystem 920 comprises a core fuel cell subsystem 930 and a thermal management subsystem 932 with fuel cell cooling module 934. The thermal management-subsystem, can be complex and handles the thermal requirements of the Fuel Cell System, Battery and Power electronics. The fuel cell subsystem 930 communicates with a DC-DC converter 936 which is in communication with a power distribution subsystem, as described later.

Battery power is supplied via an energy storage subsystem 940 which may preferably be comprised of separate high voltage and low voltage components 942, 944 respectively. The high voltage subsystem 942 may be coupled with a power distribution unit as discussed below, to exchange power and control signals while the low voltage battery subsystem 944 (suitably powered at 24 volts) may communicate with driver controls and the other power distribution unit and hydrogen fuel cell subsystems 930.

A power distribution subsystem 950 has a central power distribution unit and powertrain controller 952, a DC-DC converter 954 in communication with the low voltage battery subsystem 944 and an e-stop module 956.

Driver control subsystem 960 comprises human machine interface 962, vehicle ancillary systems 964 including lights, horn, throttle pedal 966. The e-drive subsystem 970 comprises an inverter 972 and e-axle and receives control signals from the driver throttle pedal 966 and power distribution unit 952 and receives power from the power distribution unit 952 as well as sending power back to the battery subsystem 942 for regeneration.

The vehicle of the present disclosure may also comprise a Heating, Ventilation and Air Conditioning (HVAC) system 976, which may be for driver experience/comfort and/or refrigeration of cargo. This may be in communication with the driver human machine interface 962 and exchange coolant with the thermal management subsystem 932.

In addition, the vehicle of the present disclosure comprises a hydrogen flow meter 980 that measures the quantity of hydrogen supplied by the hydrogen subsystem 918 to the hydrogen fuel cell subsystem 920. The control system 902 may also include a firewall 978 to filter information sent to the power distribution unit 952.

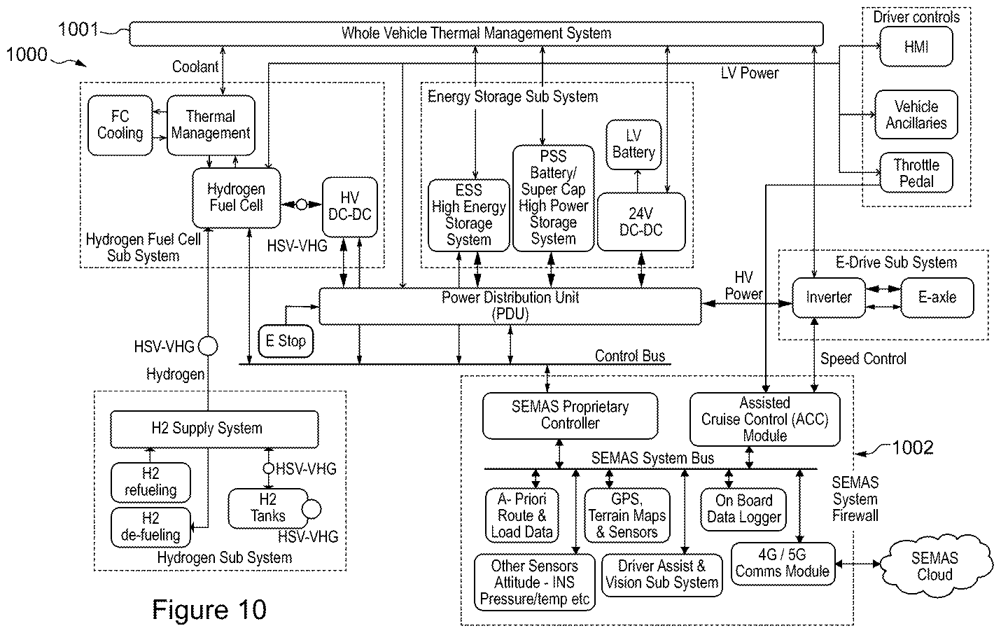

FIG. 10 illustrates details of a further exemplary vehicle architecture 1000 containing similar components and being in line with that shown in FIG. 9. This vehicle architecture 1000 comprises a SEMAS system controller 1002. In this embodiment it is the SEMAS Controller that controls the velocity of the vehicle in response to either a velocity request from the driver (through the throttle pedal) or from a predefined target velocity profile (as a form of adaptive cruise control) from drive module 150. The e-drive subsystem then pulls power from the HV power distribution unit to satisfy the target velocity set by the SEMAS controller.

The vehicle architecture 1000 of FIG. 10 shares similar components as the architecture 900 of FIG. 9, with the addition of a more explicitly drawn whole vehicle thermal management system 1001 and various other components.

The SEMAS system controller 1002 is now in the loop between the driver throttle pedal and invertor to adjust the rate at which the vehicle accelerates: this is in the form of a fail-safe module labelled Assisted Cruise Control (ACC) in the diagram, which can take over the throttle response but will be able to be overridden by braking and acceleration functions.

FIG. 10 also shows additional details on the inputs to the Hydrogen Fuel Gauge, called the Virtual Hydrogen Gauge or (VHG). A plurality of different sensors may be provided, and the actual data may be derived from a combination of these, preferably at different parts of the drive cycle and fuel gauge readings. Appropriate sensor fusion techniques can be used, and different sensor readings can be given different weightings depending on their relative importance.

Here, the energy storage subsystem (ESS) is more complex and shows separate high energy capacity and high-power capable components. The high-power capable component may be a high-power battery, or supercapacitor and this component will to provide the short-term high-power transients. The high energy capacity component (which may be more limited in peak power charge and discharge) is then protected from experiencing these high charge discharge demands and provides the main energy store. The SEMAS controller 1002 in this embodiment will then adjust power flows between the high energy and high-power components of the ESS to maximise the overall life of the ESS. In this role the SEMAS controller 1002 use predictive modelling techniques assess power balance and dynamically set the outputs of each of the components of the ESS and the Fuel Cell subsystem to achieve the required drive characteristics.

A representation of the forces on a vehicle 700 of the present disclosure are illustrated in FIG. 11. The notations are as follows:
dg: distance of centre of gravity in front of rear wheels
w: wheelbase length
hg: height of centre of gravity from the ground
A: Frontal Area=5.2 m2
ρ: density of air
g: gravitational acceleration
Fp: tractive effort
Fg=mg sin(θ): Climbing Resistance
Fn=mg cos(θ): Weight front and rear
Fd=(Cd ρ A v\hat{ }2)/2: Drag
Ff, Fr: Front and rear rolling resistances

It is also noted that m·dv/dt=Fp−(Fr+Ff+Fg+Fd)

As a strictly non-limiting example, the following may represent typical values for an HGV:

Ratio dg/(w−dg)=2000/3600, and w=3600, so dg=1285.74 when fully laden. Weight distribution on the flat could be 40%/60%, hg loaded 2900/2=1450; mass loaded=5500 kg; frontal area 5.2 m².

The tractive effort of the hybridized fuel cell powertrain of the present disclosure needs to overcome the rolling resistance, aerodynamic drag, and if the vehicle 700 is on an up incline to lift the mass of the vehicle 700 up the hill. If the vehicle 700 is also accelerating, then the power demand increases in proportion to the rate of acceleration and, significantly for an HGV, the mass of the vehicle 700. When the vehicle 700 is on the level and operating at constant velocity then the power demands are much less as the powertrain only needs to overcome such factors as the rolling resistance and the aerodynamic drag.

The effect of these and other forces may contribute to a dynamic model of the vehicle 700. A three-dimensional representation can include load transfer under cornering and the power demand.

When the vehicle 700 is on a downward incline or decelerating then a braking effort needs to be applied. Traditionally this has simply been achieved with friction brakes where the energy of forward motion is dissipated in the braking system. However, with an electrical powertrain there is the opportunity to store this energy in the ESS by reversing power flows. This is known as regenerative braking. The energy storage capacity can be chosen separately from the size of the fuel cell. Provided that both in combination can provide the peak power demand of the vehicle 700, when compatible with range requirements.

With commercial vehicles the available energy from braking can be considerable, particularly when the driver needs to decelerate the vehicle 700 on a long down incline. The ESS 704 (of FIG. 7) can be designed to make maximum use of the available regenerative energy, thus using the SEMAS system of the present invention, model predictive control can be used to set up the SOC in the energy storage system to maximise the use of regenerative braking. Thus, exemplifying SEMAS' ability to compute and analyse the optimum energy balance requirements for consideration of uploading and offloading of cargo during a logistics delivery and transportation process.

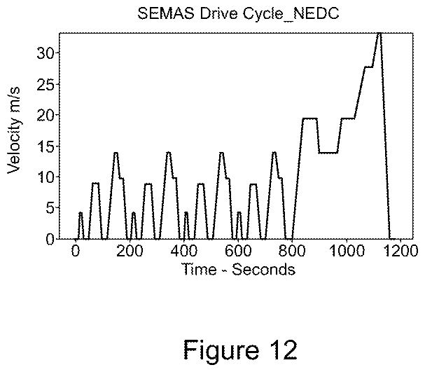

As an example, FIG. 12 shows the NEDC drive cycle. These standard drive cycles have been developed to provide standardised tests to compare the fuel consumption of different vehicles. However, these are speed-time profiles with no allowance for wind speed or gradient. The system may also be provided with several one-dimensional terrain maps derived from satellite mapping data covering common trunk roads.

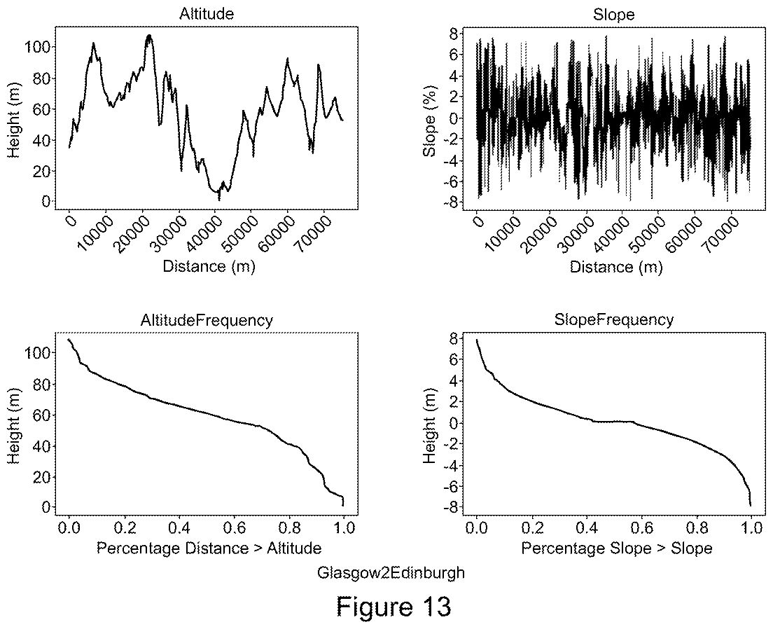

As an example, FIG. 13 shows an output from an example terrain file, showing altitude data derived from mapping for a journey from Glasgow to Edinburgh along the M8 trunk road, in Scotland. From this the gradient is calculated. These are one-dimensional spatial curves. The two bottom graphs are frequency domain version of the same data which shows the frequency of occurrence.

Real world altitude data may be taken from the available satellite navigation system datasets such as the following GPS data sets: NASA SRTM1: 30 m, ODP1, ASTER. However, these are limited to 30 m resolution and tend to report the highest elevation for each square. If a road is adjacent to a hill or cutting, then the elevation data tends to over-estimate slopes. These very sharp changes in elevation may be removed from the data set.

SEMAS, the system of the disclosure may use road survey data or accurate barometric derived data from real world journeys to correct these maps. This may advantageously take advantage of integrated inertial navigation units provided at the vehicle which are designed to accurately measure vehicle pitch and yaw to produce more accurate gradient data.

The SEMAS system's software suite may also provide the ability to produce synthetic drive cycles and synthetic terrain profiles. These may be used to test the simulated vehicle control system in a variety of extreme cases, such as an extended motorway drive cycle or a continuous long descent. These permit the evaluation of how the vehicle will behave in real world conditions or for testing the limits of the design. By combining the drive cycle with the altitude data, a real-world test applicable to LGV or HGV use can be simulated (rather than a standard drive cycle).

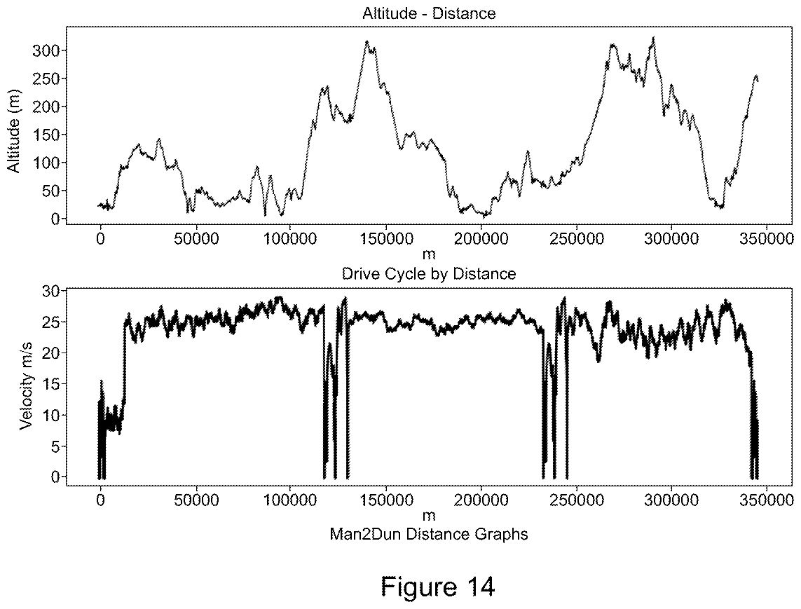

An example of a drive cycle velocity profile, together with the route terrain map, is shown in FIG. 14. Here the 1-dimensional terrain representing the journey from Manchester to Dundee on the trunk road network in the UK is combined with a real-world velocity time graph that represents a short urban stage, followed by motor way driving, trying to maintain a constant velocity with a couple of stop/start intervals.

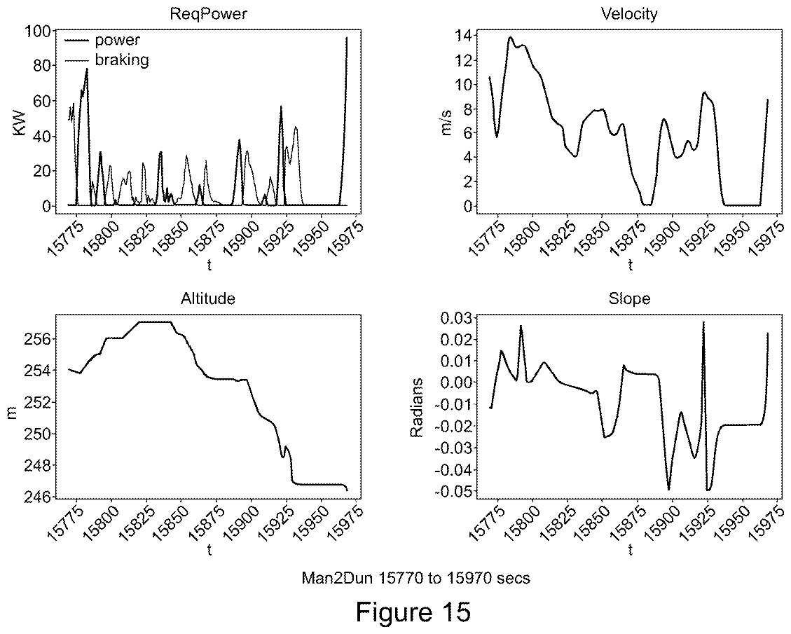

FIG. 15 shows the power demand at the wheels for a short section of the model predictive assessment of the route of FIG. 14. The top left graph shows the power demand and the power available from regenerative braking. The graphs in FIG. 15 show an example of the peak power demand for an MCV (medium commercial vehicle) simulation of around 80 kW but only for a very short period. Similarly, power peaks of almost 60 kW are experienced in braking. However, when driving the average power demand is around 40 kW. Thus, during this part of the drive cycle, the fuel cell is operated at around 40 kW, and provided the battery can store sufficient energy to meet the demand for the peak by providing a short-term output of around 20 kW, the drive cycle energy requirements of FIG. 14 will be met.

However, to achieve optimum efficiency and fuel cell/battery component life, the SEMAS control system may limit the rate of rise of power demand from the battery system and be configured to limit the combined peak output, reducing strain on the battery system, but with the consequence of limiting the acceleration of the vehicle below that demanded by the drive cycle.

Because the SEMAS control, system includes a-priori elements, the SEMAS controller can predict in advance where the acceleration peaks will occur (due to terrain) and be able to slowly ramp up the fuel cell power output to avoid the battery being required to produce the large rapid peak in power output. This scenario may have the effect of adversely impacting overall fuel efficiency.

The SEMAS control system can also provide an environment subsystem, which senses and provides environmental inputs that represent physical external signals that act on the vehicle, including one or more of: road slope, wind/drag force, wind speed and direction, environmental temperature. These data points may also be used for the thermal model.

A more detailed list of system parameters is enumerated here for exemplary purposes:

| Name | Description |
|---|---|
| Route Descriptors | |
| Distance | Distance along the selected route |
| Terrain | One dimensional sequence of altitude along the route. |
| | Altitude distance pairs |
| Slopes | the gradient - array of gradients given as distance slope pairs |
| Initial Gradient | spot estimate of gradient at current position |
| Current Slope | spot estimate of gradient at current position |
| Drive Cycle | Velocity/Time graphs as set velocity time pairs |
| Drive Cycle Name | Name assigned to standard drive cycles |
| Velocity | Vehicle velocity |
| | Requested velocity - (either from driver or drive cycle in simulation) |
| | Set Velocity - target velocity as set by SEMAS controller |
| | Current Actual Velocity |
| | Maximum velocity as set by speed limiter |
| Acceleration | Acceleration/deceleration of the vehicle |
| | acceleration requested by driver or drive cycle |
| | acceleration set |
| | acceleration current |
| | maximum acceleration as a limit |
| | breaking or retardation - live acceleration |
| Force | Force |
| | Front Rolling resistance expressed as Force in Newtons- |
| | measured as normal to ground |
| | Rear Rolling resistance expressed as Force in Newtons |
| | measured as normal to ground |
| | Aerodynamic drag in Newtons |
| | Climbing resistance due to gravity (+ve) or downhill force (−ve) |
| | Force produced by the powertrain |
| | gravitational constant |
| | density of air |
| | Cross Sectional Area |
| | Height of CoG above ground plane |
| | wheel base |
| | distance of CoG in front of rear wheels |
| Power | Power usually expressed in kW in the model |
| | Power produced by the powertrain at wheel |
| | Power output of the Fuel Cell at input to DC/DC convertor |
| | Power input or output to the Battery system at the battery terminals |
| | Power requested at the wheels by the driver or drive cycle |
| | Power losses in the DC/DC convertor |
| | Power losses in the balance of the transmission |
| | Sum of Power used in the auxiliary systems (pumps, fans, AC and others) |
| | Power input to the Fuel Cell expressed as kW |
| | Power input to the Fuel Cell expressed as kg/s of hydrogen |

It will be appreciated that the SEMAS system of the present disclosure may employ further parameters and does not have to use all the parameters listed in the table above; this table is provided as an exemplary embodiment only. Examples of other signals that can be measured by the SEMAS control system may include one or more of:

Vehicle air speed, Current Vehicle speed, requested vehicle Speed, Current Power to wheels, Current Regeneration, Battery Power Flow, Mode Maximum allowable battery pack discharge current, Mode Maximum allowable battery pack charge current from regenerative braking, Mode Max Battery, Pack Temp, Mode Min Battery Pack Temp, ModeMax SOC, ModeMin SOC, ModeMaxFCOutput, ModeMinFC Output, FC Power out, FC Stack Temperature, Mode FC Max Up ROC, Mode FCMax Down ROC.

The SEMAS system of the present disclosure may also be provided with a vision system (not shown) that preferably comprises a fusion of radar and LIDAR modules. These are part of the sensors and data for the traffic module 170 As an example, the vision system can measure or provide one or more of: distance to vehicle in front, tracking vehicle in front speed (within limits), warning on lane drift, emergency braking, 360-degree vision. These signals may be used to provide within the drive module 150 a request velocity profile in the form of an enhanced cruise control data into the SEMAS controller. This will not necessarily be a constant speed request but could also take account of traffic awareness to maximise use of slip steam drag reduction and smooth out velocity changes. The drive profile requested may also be used to provide an anticipatory drive mode, where vehicle speed or acceleration adjustments are made to anticipate obstacles or slowing down of traffic, for example to minimise ramp rates within the vehicle sub-systems.

The SEMAS system of the present disclosure uses machine learning to further optimize vehicle performance and reduce total cost of ownership. A machine learning system can compare the current progress over the route with historical progress over the same route. This is useful especially for the LGV or HGV sector where vehicles often repeat the same route multiple times per week. On-board data logging of the parameters can be used to refine the library terrain maps and GPS route data and the historical power demand curve to provide improvement in the power demand projection and so reduce ramp rates and loads on the powertrain subsystems on a continual improvement basis. The SEMAS system can learn how to optimise control of the various subsystems to meet driver demands while minimising fuel consumption.

The GPS (or other satellite navigation sensor) and on-board data logger provide the opportunity to send high spatial resolution data of the powertrain system components linked to the geo-position. This, in turn, enables the use of machine learning techniques to refine the vehicle settings for that element of the route in future while taking into account variable parameters including the vehicle load, and environmental and traffic conditions.

It is then possible to monitor battery state of charge and adjust fuel cell power output at a low rate to ensure that rate limitations are met, and that battery power output is available for when it is required.

The SEMAS system may also provide an improved fuel gauge, which may be used for measuring gaseous or multi-phase materials hydrogen. With conventional liquid fuels it is usual to use a liquid level gauge of some form and infer quantity of fuel remaining by calibration of the level against the known geometry of the fuel tank.

For a gaseous fuel held at high pressure, the simplest measurement is to measure the current gas pressure and from this infer how much hydrogen is within the fuel storage tanks from the remaining useable pressure. This is an approximately linear relationship as hydrogen behaves similar to an ideal gas. However, with available pressure gauges this is a relatively inaccurate measure, particularly within an LGV or HGV where multiple tanks are coupled together and the accuracy with which pressure is measured does not provide an accurate measure of the available gas.

It is also important to know the rate of consumption of hydrogen. This can be inferred from the fuel cell output and the fuel cell efficiency map.

Coriolis meters are available to measure mass flow but are expensive and ideally suited to static use. Not only is it technically difficult to accurately measure mass flow of hydrogen; there is no readily available method to produce an accurate hydrogen fuel gauge.

The hydrogen metrology problem has implications for accurately establishing the range of the vehicles and means that a reserve tank or buffer amount must be provided. This in turn means that the vehicle is unlikely to achieve the full range available from the on-board hydrogen store.

The present disclosure provides adapted cylinder mounts that allow for a direct measurement of the mass of hydrogen, by measuring the gross weight of the hydrogen and the storage device. Calibration against the empty weight will provide a direct measurement of on-board mass of hydrogen. Accurate hydrogen metrology is necessary to reduce the margin of error on the range prediction and reduce fluctuating estimates that cause range anxiety.

For dispensing hydrogen gas, existing standards (such as SAE J2601) already require communication between the vehicle and hydrogen refuelling system (HRS) to ensure connection is made and to measure temperature and pressure the mass dispensed can then be measured.

As the fuel gauge electronics will record the empty mass of each cylinder, the instantaneous mass of hydrogen remaining can then be calculated from the gross weight of each cylinder.

As noted, on board flow measurement of hydrogen is also difficult. A simple differentiation of the mass with time will allow a mass flow estimate. The system will correlate several parameters and power measurements on the output of the fuel cell to give instantaneous fuel cell efficiency.

The efficiency measure and residual fuel inventory can be used by onboard telematics to calculate the residual range available, both dynamically and accurately.

The SEMAS controller of the present disclosure can use this information, together with vehicle destination information, to dynamically adjust the power output of the fuel cell and manage the energy balance between battery and fuel cell subsystems to ensure that the vehicle reaches its destination, albeit with a temporary performance limitation.

The embodiments of the present disclosure provide a vehicle and powertrain simulation which provides a high-fidelity hybrid FCEV simulation tool to optimise system integration and demonstrate performance against a very wide range of vehicle duty cycles, using real world terrain maps in combination with other factors, such as, operational constraints on the specified powertrain components.

Add-on modules provide for operational cost assessment, environmental assessment and modelling the operation of the refuelling infra-structure at the depot level.

Each of the system modules of the SEMAS control system can be provided as stand-alone modules with a well-defined input/output interface. Data can be transferred in intermediate data files that are in text format and can be opened and read with any text editor. This provides a great deal of flexibility in using the SEMAS system and facilitates the compilation of an extensive customised library of performance and operational data. Thus, making it is possible to swap out and replace powertrain system components. For example, one can swap out a fuel cell subsystem, change the data map and re-run the whole vehicle simulation of the refurbished vehicle against the same terrain and duty cycle.

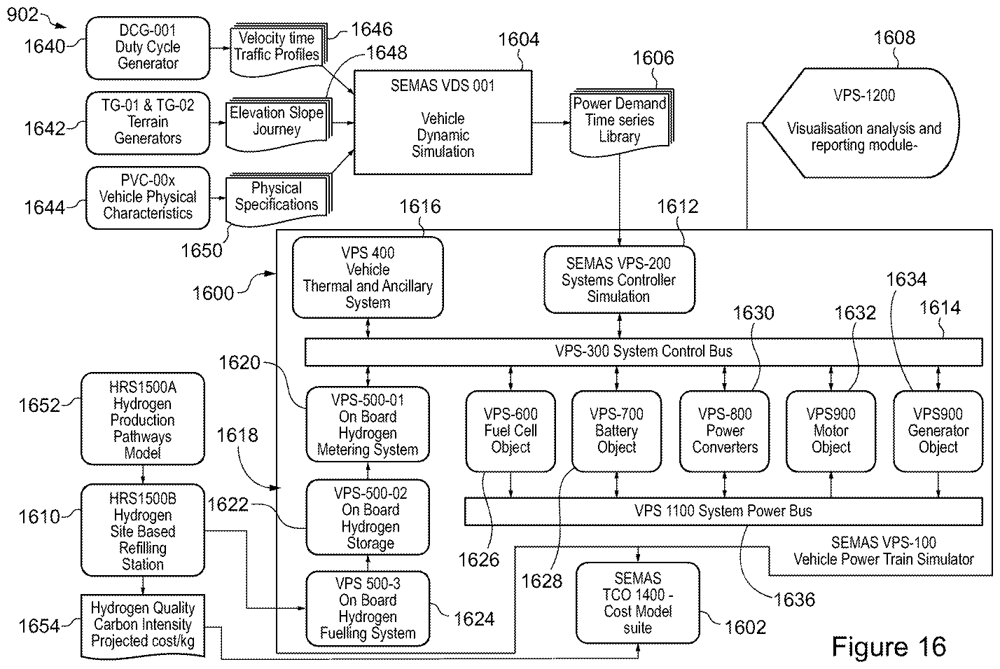

FIG. 16 shows a further detailed schematic of the SEMAS modelling suite illustrating the relationship of the model to a physical embodiment as illustrated in the control system 902 showing its subsidiary components. The SEMAS control system 902 comprises an abstraction of vehicle powertrain simulator 1600 that provides output to a total cost of ownership cost model suite 1602. The powertrain simulator 1600 also receives inputs from a vehicle dynamic simulation module 1604 via power demand time series libraries 1606 and from visualisation analysis and reporting module 1608. Further input to the vehicle powertrain simulator 1200 is provided by a hydrogen site-based refilling station 1610. A system controller module 1612 provides a simulation of the onboard SEMAS control system 902. Here resides the central control algorithm of the SEMAS control system for controlling the hybrid energy subsystem making decisions on how to best meet the power demand of the powertrain. Its inputs include such parameters as: the power demand, route, load, available capacity of each of the powertrain components, the fuel supply, and the route to complete; and it provides an output of system controller state data.

The control signals 1614 and the energy flows in the power train 1636 are represented in the software model. The control signal module 1614 holds the data representing the control signals as time series areas over the whole journey. This means that they are accessible so that a component module can run independently for testing and development. Similarly, the power output/input of each of the modules representing power train components is collected as an array of time series data. The power output times series 1636 can be summed and compared with the power demand time series 1606 to see if demand is met by the SEMAS MPC model 1612 under test. This architecture means that models of power train components can be modified individually and independently simulated within the context of the whole vehicle simulation model. It also allows simulation of the entire powertrain, with the exception of a real component to facilitate hardware in the loop testing where the control signals are fed to a real component and its outputs are captured and fed back into the model.

The SEMAS control system 902 comprises a thermal module 1616 which handles the thermal output from the fuel cell and the onboard routing of thermal energy to provide battery heating and cooling and environmental control of the vehicle cab, and cargo as may be required. This module 1616 also handles ancillary systems, additional heat and cooling as heat or onboard stationary power. The thermal module 1616 is provided with inputs comprising components [specifics] that make up the thermal and ancillary electrical systems of the vehicle, such as lights and heating, and provides outputs comprising state data of the ancillary heat, power, and cooling systems.

A hydrogen system 1618 comprises three subsystems: a model of the onboard hydrogen metering system 1620, an model of onboard hydrogen storage device 1622 and onboard hydrogen fueling system module 1624. In combination, these subsystems simulate the operation of the onboard integrated hydrogen system 1618. This includes hydrogen storage states including quantity, pressure, and vessel temperature. Inputs to the hydrogen system 1618 comprise the hydrogen system operational parameters and limits; and outputs comprise state data of the hydrogen supplies, including quantity, temperature, and pressure. While this is a model representation of a gaseous hydrogen storage system, it is also possible to model and alternative hydrogen storage systems such as cryogenic liquid hydrogen, hydride storage or ammonia storage and convertor.

A fuel cell model 1626 is provided that uses fuel cell operational maps to transform input to output and tracks its internal state data. Its inputs are provided as fuel cell efficiency maps and it provides outputs of state data such as fuel cell heat, power output and internal temperature. A battery object 1628 is provided to simulate performance of the battery or battery bank of the vehicle of the present disclosure. It is provided with battery efficiency maps (typically provided by the manufacturers of the battery) and it tracks the battery's inputs, outputs and rate of charge or discharge. It provides as an output the state of charge, energy inflow and outflow and the internal temperature of the battery, among other things.

A power converter object 1630 contains state data and efficiency maps of the power conversion models including DC-DC converters and AC-DC converters. Its inputs include power converter efficiency maps and rate limits of the power conversion subsystems, and it provides state and converter outputs.

A motor object 1632 represents the main e-axle component which provides the motor generator and conversion to and from electrical power to motive force. This module 1632 comprises the efficiency maps of the various components that make up the e-axle. Its inputs comprise the full e-axle module maps and it provides outputs of electrical to kinetic power conversions and back again. These functions may be provided by a separate motor object 1633 and generator object 1634.

A system power bus 1636 exchanges data with the objects 1626 through 1634 and provides a data conversion function translating energy and power demand to voltage and current at the levels necessary for the various powertrain subsystems. Its inputs include energy flows through the various powertrain subsystems and power routing information, which it provides as outputs power routes and energy balance.

The model visualisation module 1608 provides statistical analysis and visual outputs such as graphing functions and simulation reports. It is provided with an output file from the powertrain simulator 1600 and provides a simulation readable report as its output. As mentioned above, the vehicle powertrain simulator 1604 is a dynamic simulation that receives power demand time series for the physical vehicle and the selected traffic duty operational duty and drive cycles. These as provided by duty cycle generator 1649, terrain generators 1642 and vehicle physical characteristics module 1644.

The duty cycle generator 1640 comprises a library of standard drive cycles. These may preferably include drive cycle specifications, such as TRL PPR 354¹, but may also include customer derived cycles relating to typical reference routes and traffic data. This duty cycle generator 1640 allows preparation of custom drive cycle by sampling, scaling and containing drive cycles to provide a test cycle adapted to customer specification or for a specific test such as a downhill endurance test. It may be provided with standard library of drive cycles and customer derived drive cycles, and it provides an output of velocity time traffic profiles 1646 which comprise vehicle test drive cycles expressed as velocity time series. ¹ TRL is a wholly owned subsidiary of the Transport Research Foundation (TRF), a non-profit distributing company limited by guarantee, and established for the impartial furtherance of transport and related research, consultancy, and expert advice. They publish standard duty cycles, specifically a reference Book of Driving Cycles for use in the measurement of road vehicle emissions, such as Published Project Report PPR354

The terrain generators 1642 comprise two alternative terrain generation modules. The first terrain generator may provide for development of realistic test routes based on map data for a route under investigation. Real routes can be used as the basis for creating artificial routes; for example, if the data for real routes (say a drive cycle over a hill) is obtained, then that data could be segmented and the vehicle could then be presented with a series of hills to test the control algorithms over a more challenging terrain. It can also use samples of synthesised route data from the other terrain generator sub-component. The module 1642 receives as inputs GPS terrain data and map data and provides as an output elevation, distance and slope distance maps for the selected route.

The second terrain generator module provided as part of module 1642 may be used to provide synthetic or idealised routes. These are used for stress testing the design and may include, for example, extended gradients or a series of upward and downward slops to test the energy flows for energy storage regeneration and peak power demands. It receives as inputs a series of desired route parameters, such as maximum gradient or number of flat or hill sections and provides as outputs a set of elevation slope journey files 1648 which provide elevation/distance and slope/distance maps for the selected synthetic route.

The physical vehicle characteristic module 1644 is used to prepare a parameterised physical model of the vehicle under test. Parameters may include weight, wheel loading, load carried and drag factor. As its inputs, it receives a series of vehicle parameters and it provides structured output file 1650, with input and calculated parameters describing the physical model of the vehicle.

Therefore, with these inputs, the vehicle dynamic simulator 1604 module provides a dynamic simulation of the physical vehicle with the selected drive cycle against the route selected and terrain and produces a time series energy demand at the vehicle wheels. It is provided with output files from the other components 1640, 1642, 1644 and provide as outputs a power demand time series library 1606.

The SEMAS control system 902 may also be provided with a hydrogen production pathways model 1652. This model 1652 provides a well to tank analysis of the fuel cell electric vehicle to determine overall hydrogen demands, system efficiency at fleet and vehicle level and carbon intensity taking into account a hydrogen source pathway and fleet vehicle inventory and duty cycle, hydrogen storage capacity and flow rates. This model 1652 provides an output for the hydrogen site based refilling station 1610 comprising the filling demand model, wait times and number of vehicles serviced. Here, the “hydrogen source pathway” refers to how the hydrogen is produced, stored transported and dispensed—it is useful to classify hydrogen according to the source pathway. The pathway may define the primary energy source (fossil gas biomethane, electrolysis, renewable or non-renewable electricity)—each of these pathways will have different carbon contributions and so the carbon intensity of the hydrogen will be different. This is not the actual carbon in the hydrogen, but rather the carbon emitted in making the hydrogen.

The cost and environmental module 1602 provides a total cost of ownership and environmental comparative data for specific fuel cell electric vehicles and their diesel equivalents running similar duty cycles. It is provided with inputs of fuel cost projections, Capital Expenditure (CapEx) and Operational Expenditure (OpEx) cost models and fuel carbon intensity factors, and it provides outputs of TCO and environmental savings.

An input to the cost module suite 1602 is provided by output files 1654 which are output from the hydrogen site-based refilling station module 1610 and comprising hydrogen quality, carbon intensity and projected cost per kilogram data.

The vehicle powertrain simulator 1600 is a simulation model of the vehicle's powertrain. This contains a system description of the vehicle and runs the main simulation of the energy flow of the vehicle. The module 1600 allows a user to select the powertrain subsystems and configure them to work together. The components themselves are parameterised objects which contain state data. The module 1600 steps through the energy demand time series input from the time series library files 1606 and calculates the I/O and state of each of the connected objects described elsewhere.

The inputs for the module 1600 include the power demand time series data 1606 for the physical vehicle, and the selected traffic duty, operational duty, and drive cycle. The module 1600 then outputs a times series of the parameters/state and alarm of each of the powertrain subsystems of the module 1600. It also shows where the required duty cycle is not met and can also calculate the operational margin of the powertrain—when knowing the whole operating envelope of the powertrain subsystems, this high fidelity SEMAS model of the present disclosure can compare the actual output of each to the operational maximum and derive the available margin or headroom on each subsystem.

Relationship Between TCO and Least Cost

Total cost of owner ship is often used to compare different vehicles. To do this the calculation basis needs to be the same. Therefore, fuel consumption is measured using standard drive cycles under similar conditions. We prefer the term least cost optimisation. Because with SEMAS we aim to optimise at all system levels to control variable factors that affect TCO from a system energy management perspective. These factors will include route selection, fueling strategy, condition monitoring (as part of planned preventive maintenance), and controlling energy and power flows to enhance durability of the subsystems and the primary energy demand of the vehicle.

Relationship Between SEMAS and Autonomous Driving

6 different Autonomous driving levels have been defined by the SAE. As shall be described, the SEMAS system of the present invention provides different functions at different levels of autonomy. The SEMAS Controller is a supervisor controller that takes data input from a wide range of sensors and subsystem states to manage energy flows between the various sub systems.

At autonomy level 0 SEMAS is transparent to the driver it is working to optimise the balance of energy between the FC and ESS to ensure that the FC and ESS are in a state to maximise regenerative braking or to work in parallel with the FC to meet the peak power demands of the driver. The predictive element is taken from the set route and the calculation of likely power profile given the performance setting of the vehicle (max performance, normal or eco mode set by driver or fleet manager for this route). Driver information is limited to range remaining and predicted time to destination.

At autonomy level 1 SEMAS will limit power available at points on the route to deliver a least cost power profile while maintaining the drive characteristics that the driver (or fleet manager) sets. It will also inform the driver of status and warn of condition and provides guidance on ways to improve the energy performance.

At autonomy levels 2-5 SEMAS will take control of the longitudinal progress of the vehicle with a form of adaptive cruise control and use the EBS system. Rather than maintaining speed it will cuts acceleration and increase/decrease speed in response to the terrain and traffic.

SEMAS will switch from level 0 to level 1 to provide range extension if the route changes and range is recalculated where the pervious performance level for calculated for the route can no longer be met to reach the next fueling point or destination.

Commercial vehicles may be classified for tax and other purposes according to their gross combination mass and/or a range of other factors such as intended use, construction, engine, type of fuel and emissions. Terminology can vary between different licensing and taxation regimes. For the purposes of the present disclosure, a Light Goods Vehicle (LGV) is defined as being commercial carrier vehicles with a gross combination mass under 3,500 kg, and a Heavy Goods Vehicle (HGV) as having a gross combination mass of 3,500 kg or greater. As a non-exhaustive list of examples, a typical LGV may be a pick-up truck or a van, while a typical HGV may be a dry and consumer goods truck, a flatbed truck, curtain cider, tanker, transporter. It will be appreciated that unless specifically stated otherwise, the present disclosure is not limited to any vehicle classification, that is, the principles disclosed herein can apply generally to HGV, LGV or even to domestic vehicles.

Various regulations and licenses apply depending on the expected gross weight. For HGVs, hydrogen fuel cell systems and/or drivetrains can offer a viable zero emission alternative to diesel-powered systems and, in addition, can be more viable as compared with battery electric vehicles because a fuel cell electric vehicle set up is able to pull heavy loads, has a long duty cycle and range capability and offers a quick refuelling time.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and examples relating to one embodiment may be combined with any other embodiment appropriately, done in different orders, or done in parallel. In addition, the systems and methods described herein may be performed in real-time. It should also be noted that the systems and/or methods described above may be applied to, or used in accordance with, other systems and/or methods.

All the features disclosed in this specification (including any accompanying claims, abstract, and drawings), and/or all of the steps of any method or process so disclosed, may be combined in any combination, except combinations where at least some of such features and/or steps are mutually exclusive.

Each feature disclosed in this specification (including any accompanying claims, abstract, and drawings), may be replaced by alternative features serving the same, equivalent, or similar purpose unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract, and drawings), or to any novel one, or any novel combination, of the steps of any method or process so disclosed. The claims should not be construed to cover merely the foregoing embodiments, but also any embodiments which fall within the scope of the claims.

Throughout the description and claims of this specification, the words “comprise” and “contain” and variations of them mean “including but not limited to”, and they are not intended to (and do not) exclude other moieties, additives, components, integers, or steps. Throughout the description and claims of this specification, the singular encompasses the plural unless the context otherwise requires it. Where the indefinite article is used, the specification is to be understood as contemplating plurality as well as singularity, unless the context requires otherwise.

All the features disclosed in this specification (including any accompanying claims, abstract, and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract, and drawings), or to any novel one, or any novel combination, of the steps of any method or process so disclosed.

It will be appreciated that various modifications can be made to the above without departing from the scope of the disclosure. For example, while references have been made to a “driver” herein, it will be appreciated that the disclosure also applies to autonomous vehicles which either have driver assistance technologies, or no driver at all.

1. A control system for a vehicle comprising a powertrain comprising a plurality of energy sources, the plurality of energy sources comprising a battery, the control system being configured to actively monitor, control and optimise power recapture from regenerative-braking in the vehicle.

2. The control system of claim 1 configured to provide one or more control signals to the powertrain, thereby controlling the regenerative-braking in the vehicle

3. The control system of claim 1, configured to maximise overall power efficiency from the regenerative-braking.

4. The control system of claim 1, wherein the vehicle is a fuel cell electric vehicle and the plurality of energy sources comprises a fuel cell.

5. The control system of claim 4, wherein the vehicle comprises a fuel cell subsystem comprising the fuel cell.

6. The control system of claim 5, wherein the fuel cell comprises a hydrogen fuel cell.

7. The control system of claim 1, wherein the vehicle is a zero-emission hybridised heavy goods vehicle.

8. The control system of claim 1 comprising:
monitoring circuitry configured to monitor the power recapture from regenerative-braking; wherein:
the control system is configured to:
determine an optimal power recapture; and
adjust the power recapture from regenerative-braking to the optimal level, thereby providing optimised power recapture from regenerative-braking.

9. The control system of claim 1, comprising one or more interfaces configured to receive inputs, the control and optimisation of the power recapture being dependent on the received inputs.

10. The control system of claim 9, wherein at least one of the one or more interfaces is a wireless communications interface.

11. The control system of claim 9, wherein the inputs comprise one or more of data from a driver of the vehicle, route data, traffic data, Global Positioning System data, terrain data, temperature data, route data, status of component data, parasitic load data, power flows in one or more subsystems of the vehicle data, DC/DC convertors and the two way DC/AC controller of the power axle data, vehicle speed and driver demand for change in speed data, temperature in fuel cell stack data, battery temperature data, current hydrogen inventory data, current battery state of charge data, current ramp rate on fuel cell data, water management data or cargo weight.

12. The control system of claim 11, wherein the data relates to current status and/or rate of change.

13. The control system of claim 1 comprising a simulation module configured to provide a simulation model of the vehicle, the control and optimisation of the power recapture being dependent on the simulation model.

14. The control system of claim 13, wherein the simulation module is configured to model one or more of the following in the generation of the simulation model of the vehicle:
thermal management, a hydrogen fuel cell; fuel cell cooling, a high voltage DC-DC converter; a HVAC subsystem, a power distribution subsystem, a PDU and powertrain controller, an energy storage subsystem, a high voltage battery, a E-drive subsystem, an inverter, an e-axle, a hydrogen subsystem, one or more hydrogen tanks, a hydrogen supply system, hydrogen refuelling, hydrogen de-fueling, a hydrogen fuel cell subsystem, a DC-DC converter, parasitic loads, a cabin heater, an e-stop, a low voltage battery, an axle-wheel-tyre subsystem, and cargo weight.

15. The control system of claim 13, wherein the simulation module is configured to provide model predictive control for controlling and optimising power recapture from regenerative braking.

16. The control system of claim 15, wherein the simulation module is configured to generate a multivariant optimization model for controlling and optimising power recapture from regenerative braking.

17. The control system of claim 15 configured to:
derive a model predictive control algorithm;
define, using the derived model predictive control algorithm, a cost function to enable optimisation of the power recapture; and
apply a control scheme based to optimise the power recapture based on the cost function.

18. The control system of claim 15 configured to:
detect information relating to a current state of charge of the battery;
provide the information relating to the current state of charge of the battery to the simulation model; and
use model predictive control to control and optimise the power recapture from regenerative braking using the detected information relating to the current state of charge of the battery.

19. The control system of claim 1, configured to control the powertrain based on the ideal operating range of components of the powertrain.

20. The control system of claim 1, configured to be operable in one of a plurality of control modes comprising a performance mode, a balanced mode, a life extension mode, a fuel efficiency mode, a dynamic range adjust mode, a range extend mode, and a driver assist mode.

21. The control system of claim 1, comprising a ramp rate module configured to implement a control algorithm to limit the ramp rate of one of the energy sources.

22. The control system of claim 21, wherein one of the energy sources comprises a hydrogen fuel cell, the control algorithm being used to limit the ramp rate of the hydrogen fuel cell.

23. A method of actively monitoring, controlling and optimising power recapture from regenerative braking in a vehicle using the control system of claim 1.
